(19) United States
(12) Patent Application Publication
(10) Pub. No.: US 2014/0087356 A1
(43) Pub. Date: Mar. 27, 2014

(54) METHOD AND APPARATUS FOR PROVIDING A CRITICAL THINKING EXERCISE

(71) Applicant: Jay Fudemberg, San Francisco, CA (US)

(72) Inventor: Jay Fudemberg, San Francisco, CA (US)

(21) Appl. No.: 14/037,258

(22) Filed: Sep. 25, 2013

Related U.S. Application Data
(60) Provisional application No. 61/705,309, filed on Sep. 25, 2012.

(51) Int. Cl. G09B 7/00

(52) U.S. Cl. CPC G09B 7/00
USPC 434/362

(57) ABSTRACT

Disclosed herein is a software application that provides a “critical thinking exercise” that presents a problem, solvable by a user exercising critical thinking skills. Each critical thinking exercise conforms to an archetype (e.g., a framework or a set of specifications) based on which each critical thinking exercise is created by an author, for a user. The critical thinking exercise archetype facilitates the exercise of user critical thinking skills. The user can analyze a number of author specified investigation scenes, identify the problem, select author pre-defined hypotheses, and form arguments supporting or falsifying the hypotheses with user-selectable items such as: evidences, inferences, conclusions, and conclusion confidence levels provided in the critical thinking exercise by the author. A solved problem entails that collection of user-formed arguments that resolves the problem to the highest level of certainty possible. The framework also includes tools that facilitate the author in creating each critical thinking application.

### CROSS-REFERENCE TO RELATED APPLICATIONS

This application claims the benefit of U.S. Provisional Application Ser. No. 61/705,309 titled “Highly Structured Digital Interactive Mysteries,” filed on Sep. 25, 2012, which is incorporated herein by reference in its entirety.

A portion of the disclosure of this patent document contains material which is subject to copyright protection. The copyright owner has no objection to the facsimile reproduction by any-one of the patent document or the patent disclosure, as it appears in the Patent and Trademark Office patent file or records, but otherwise reserves all copyright rights whatsoever.

### TECHNICAL FIELD

The disclosure relates to software applications that exercise critical thinking skills, and more specifically, to software applications that exercise critical thinking skills through the use of a collection of activities that can include investigation, logical reasoning, probability, and critical feedback.

### BACKGROUND

With computers and intelligent mobile devices becoming ubiquitous worldwide, there is steadily increasing demand for different types of software. One area in which there is a particular need is software applications that exercise critical thinking skills, particularly (though not exclusively) in the field of education. Certain existing software applications that exercise critical thinking skills require the user to make observations from presented evidence, and then formulate hypotheses, in attempting to identify the correct solution to a logical reasoning problem. Existing software applications of this type tend to be rule-based. They receive inputs from the user via free-form text entries and then apply the text entries to preprogrammed rules to interpret and determine the nature of the user's hypothesis or request for a particular investigation, e.g., using a combination of key word usage and phrase interpretation. They then provide, to best of their programmed ability, output back to the user enabling the user to proceed in the investigative and reasoning process.

For such an application to perform satisfactorily, the author of the application needs to anticipate, during the authoring process, essentially every hypothesis and investigative path that a user may take, whether correct or incorrect, and must also program the application to respond appropriately. The application can perform poorly or be non-responsive if the user enters text that was not anticipated by the author or cannot be properly interpreted by the software. Yet it may be impossible or at least impractical for the author to anticipate all possible user specified hypotheses and investigative paths without significant research and testing, and where the domain of the investigation is potentially rich in information, the task confronting the author to specify the set of necessary application rules for interpreting the user's entry of potential investigations and hypotheses, can be extremely large, burdensome, and challenging to complete.

Furthermore, authoring of software applications, particularly rule-based applications, tends to require that the author have software programming expertise. Consequently, it can be difficult and expensive for individuals who lack such expertise to create software applications to exercise critical thinking skills (or for other uses). This significantly hinders critical but non-technical individuals from converting innovative ideas for software applications into real products and greatly reduces the pool of potential software application authors.

Further, current applications that exercise critical thinking skills do not incorporate probability in the investigative and reasoning process. This can be a significant drawback, since probability (e.g., the likelihoods of different hypotheses being true or false) can be a significant factor in resolving the question addressed by a critical thinking application, and the proper use of such probability assessments is an important part of the critical thinking process. Additionally, existing software applications that exercise critical thinking skills lack robust and structured scoring and explanatory feedback methodologies. As a result, the user, upon arriving at an incorrect conclusion, may not understand where and why he made a mistake. This shortcoming tends to undermine the usability and user appeal of the application.

### BRIEF DESCRIPTION OF THE DRAWINGS

FIG. 1 illustrates an environment in which an application for exercising critical thinking skills (“critical thinking application”) can be implemented.

FIG. 2 is a flow diagram illustrating a process of solving a problem presented by a critical thinking exercise generated by the critical thinking application.

FIG. 3 shows an example of an investigation scene that may be presented by the critical thinking exercise.

FIG. 4 is an example of a “Potential Investigations” list of an investigation scene in the critical thinking exercise.

FIG. 5 is an example of a “Potential Hypotheses” list of an investigation scene in the critical thinking exercise.

FIG. 6 illustrates an example of a “Hypotheses to Conclude” list in the critical thinking exercise.

FIG. 7 is an example of a “Potential Evidence” list of an investigation scene in the critical thinking exercise.

FIG. 8 is an example of an “Inferences and Conclusions” list in the critical thinking application.

FIG. 9A is an example of a work area for forming arguments in the critical thinking application.

FIG. 9B is another example of a work area for forming arguments in the critical thinking application.

FIG. 10 is an example of a work area containing a user selected hypothesis and a user-constructed argument that supports or falsifies the user selected hypothesis in the critical thinking application.

FIG. 11 is an example of a score report generated by the critical thinking application.

FIG. 12 is an example of an explanatory feedback report generated by the critical thinking application.

FIG. 13A is an example of a hypotheses specification form of a critical thinking application authoring tool.

FIG. 13B is an example of a scene specification form of a critical thinking application authoring tool.

FIG. 14 is a block diagram of a system and technique for creating a tool for authoring a critical thinking application.

FIG. 15 is a flow diagram of a process for creating a tool for authoring a critical thinking application.

FIG. 16 is a flow diagram of a process for authoring a critical thinking application for presenting a problem in critical thinking to a user.

FIG. 17 is a block diagram of a processing system that can implement features and operations of the present invention.

### DETAILED DESCRIPTION

Note that references in this specification to “an embodiment”, “one embodiment”, or the like, mean that the particular feature, structure or characteristic being described is included in at least one embodiment of the present invention. Occurrences of such phrases in this specification do not necessarily all refer to the same embodiment; however, neither are such occurrences mutually exclusive necessarily.

Described herein is an archetype (a framework or set of specifications) to enable an application author to easily create a software application that exercises critical thinking skills (hereinafter “critical thinking application,” “software application” or simply “application”) within the context of any topic specified by the author. The archetype allows such an application to be created without requiring the author to have software programming capability or other specialized software expertise. The application created using the archetype presents, when executed by a machine-implemented processing system, to an end user (hereinafter simply “user”) an interactive critical thinking exercise. That is, the software application, when executed by a machine-implemented processing system, generates a critical thinking exercise for interactively presenting to the user and enabling the user to solve a problem using critical thinking skills. The software application exercises critical thinking through the use of a collection of activities that can include: investigation of various information items, identifying a problem to be solved (which problem could take the form of an unresolved question), specifying one or more hypotheses that may solve the problem (or resolve the question), collecting applicable evidence, supporting or falsifying each of the potential hypotheses using evidence-based logical reasoning, reaching an overall conclusion about the solution to the problem with a level of certainty that is consistent with the collection of properly argued hypotheses, and receiving quantitative and explanatory corrective feedback that evaluates such critical thinking skill activities.

More specifically, a user engaged in solving a problem presented by the critical thinking exercise can discover and analyze a number of investigation scenes (which may be presented, for example, visually, audibly, tactilely, or a combination thereof), collect evidence items from and/or based on the analyzed investigation scenes, select those hypotheses that can advance understanding of the solution if supported or falsified, form a logical argument to support or falsify each such hypothesis by selecting and sequencing appropriate collected evidence items, appropriate inferences an appropriate conclusion and an appropriate conclusion confidence level, all of which, if completed for each of the necessary (i.e., productive) hypotheses as prescribed by the application author, solves the problem to the highest possible level of certainty. That is, the user can solve the problem by using critical thinking skills. To form an argument for supporting or falsifying a particular hypothesis, the user selects the particular hypothesis and the argument items of the argument, such as evidences, inferences, conclusion, and confidence level of the conclusion, from various pre-defined lists of hypotheses, items of evidence, inferences, conclusions, and conclusion confidence levels, which lists appear in various locations throughout the creating thinking exercise as specified by the application author. The critical thinking exercise can also provide hints that can assist the user in solving the problem as well as “red herrings” (evidence that is designed to mislead the user in solving the problem or that is not relevant to the solution).

Further, the critical thinking application can also provide a detailed scoring and explanatory corrective feedback about the solution provided by the user. In some embodiments, the critical thinking application can provide a crime investigation exercise, a diagnosis of a patient, a puzzle, explanation of a causal relationship of some phenomenon, the resolving of any type of question such as who, what, where, how, when, or why concerning any topic, real or fictional, and involving any scope of detail all as specified by the author, or any other exercise that can be solved by critical thinking.

In some embodiments, the archetype of the critical thinking application is designed such that a user of the application is required to form an argument supporting or falsifying one or more of the user selected hypotheses by selecting the necessary applicable argument items from various predefined lists, and combining the argument items in a particular way to form the argument, all as specified by the application author.

The application authors are provided with authoring tools to create applications to provide various critical thinking exercises. The tools facilitate the application authors to create critical thinking applications that, when executed by a machine-implemented system, generate critical thinking exercises conforming to the archetype. The tools can ensure that the application author has created the critical thinking application conforming to the archetype, and that the application author has provided data that may be necessary for the user in solving the problem. The tools also provide the application author with the means to provide “red herring” items that can mislead the user, hints that can help the user and scoring and explanatory feedback information that enables user to rate his/her performance relative to the author prescribed solution and to learn qualitatively what was done incorrectly and why.

The embodiments described herein relate to a critical thinking exercise merely as an example, to facilitate description of the techniques being introduced. It will be recognized, however, that the techniques introduced here can be applied to other critical thinking software applications as well.

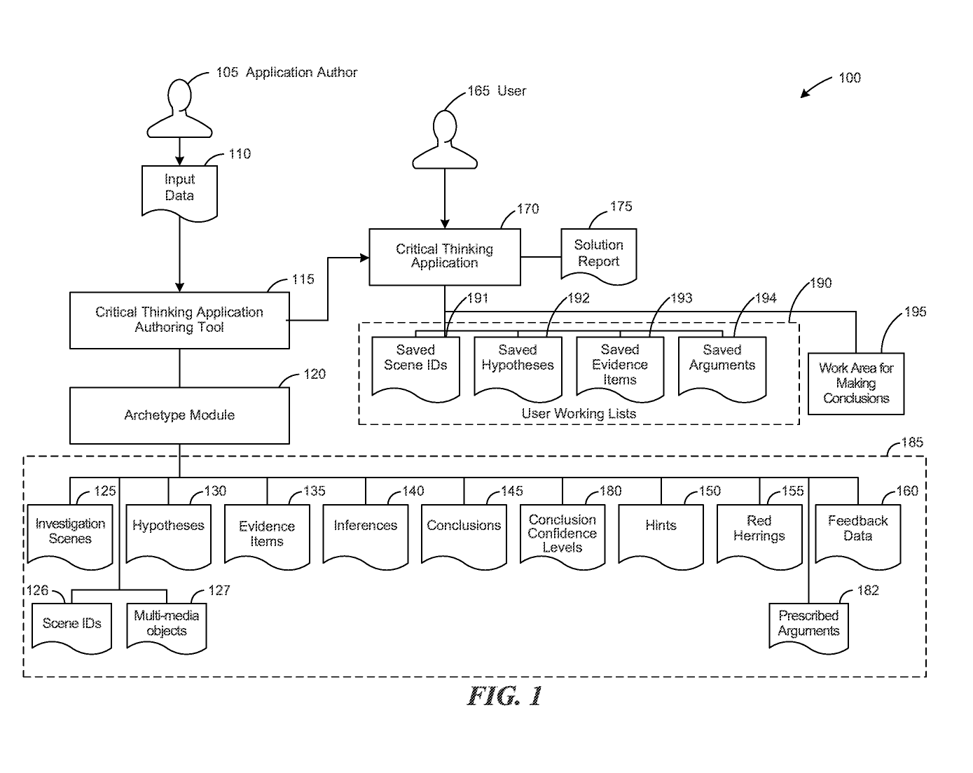

FIG. 1 illustrates an environment 100 in which an application for exercising critical thinking skills can be implemented. The environment 100 includes a critical thinking application authoring tool 115 that facilitates creation, by an application author 105, of a critical thinking application 170 that, when executed by a machine-implemented system, generates a critical thinking exercise conforming to an archetype 185 specified by the archetype module 120. A user 165 can engage with the critical thinking application 170 to solve the problem presented by the critical thinking application 170 and uses the user “Working Lists” 190 to save, review or select items during his/her scene investigation process, and to review, select and insert items during his/her argument construction activities. In some embodiments, a solution provided by the user is stored in a solution report 175.

In some embodiments, the archetype 185 of the critical thinking application 170 includes investigation scenes 125 that present information relevant to the problem presented by the critical thinking application 170, such as one or more multi-media objects 127 that might provide context, information or insights, one or more scene IDs 126 pointing to other investigation scenes that could be worthwhile to investigate, one or more hypotheses 130 that might provide a solution to the problem, and one or more evidence items 135 that could be useful to an argument that supports or falsifies a hypothesis. If the user discovers a hypothesis 130 during the investigation of a particular scene and deems it potentially productive to argue, the user saves the hypothesis into Saved Hypotheses 192. When the user 165 is ready to argue a particular hypothesis, he/she selects it from Saved Hypotheses 192 and places it into the Work Area for Making Conclusions 195, and then proceeds to construct the argument to support or falsify that hypothesis with various argument items. The user may also save the scenes he has visited or intending to visit into the Saved Scene IDs 191.

One type of argument item is evidence 135, which can be collected during a particular scene investigation 125 in which the particular evidence 135 appears. The user saves that evidence 135 into Saved Evidence Items 193 for later use during argument construction. Other argument items include inferences 140, conclusions 145 and conclusion confidence levels 180, all of which are accessible to the user when he/she is arguing the particular hypothesis to which the particular argument items of 140, 145, and 180 are associated. There may be multiple of items each of 140, 145, and 180 available to the user during the argument construction of a particular hypothesis, some of which may be red herrings. The user constructs an argument by selecting a hypothesis from Saved Hypotheses 192 and then selecting and sequencing the users 165 best estimate of the appropriate evidence items from Saved Evidence Items 193 and the appropriate available inferences 140 that help to support or falsify the hypothesis, and then applies the user's 165 best estimate to select the most appropriate conclusion 145 and conclusion confidence level 180 from those that are available.

The user repeats this argument construction process for each of the hypotheses whose support or falsification can help solve the problem. Each constructed argument is saved in Saved Arguments 194. The user 165 can stop at any time, but in order to correctly solve the problem, the user should continue investigating and constructing arguments until he/she has supported or falsified all those hypotheses that when properly argued, collectively solve the problem to the highest level of certainty. When completed and ready, the user 165 selects the option to score the effort and saves the collection of argued hypotheses to the solution report 175, upon which, the critical thinking application scoring process compares each of the user constructed arguments in the solution report 175 to the author's specification of the necessary and sufficient hypotheses and argument constructions, all as the author specified in Prescribed Arguments 182.

The archetype 185 can also include hints 150 that can assist the user 165 in solving the problem, where the user 165 may access the hints at an investigation scene, at the transition from investigating to argument construction, during the construction of an argument, and before choosing to score his/her efforts. The archetype 185 can also provide red herrings 155, which are misleading entities, that can either mislead the user from solving the problem or be not useful in solving the problem, and can be incorporated as red herring scenes, as red herring evidence items and red herring hypotheses, (the latter two of which can appear associated with particular investigation scenes 125), as red herring inferences, red herring conclusions and red herring conclusion confidence levels, which three red herring types can appear at such time the user 165 is constructing an argument for a particular hypothesis. Further, the archetype 185 can also include explanatory feedback data 160 that can be provided to the user 165 as explanatory feedback about the arguments provided and omitted, and about each argument item provided and omitted in each argument, submitted by the user 165.

The application author 105 provides input data 110, including the investigation scenes, investigation scene IDs 126, multi-media objects 127, hypotheses, evidence items, inferences, conclusions, conclusion confidence levels, argument constructions, hints, red herrings and feedback data to the critical thinking application authoring tool 115 for creating the critical thinking application 170. The author associates with each investigation scene particular items including: a multi-media object, a list of scene IDs (which list may have zero or many items and may or may not include red herring Scene IDs), a list of evidence items (which list may have zero or many items and may or may not include red herring evidence items), a list of hypotheses (which list may have zero or many items and may or may not include red herring hypotheses). The author associates with each hypothesis various items pertaining to it and the argument for arguing it, including: a list of evidence items, a list of inferences (which list may have zero or many items and may or may not include red herring inferences), a list of conclusions (which may include red herring conclusions), a list of conclusion confidence levels (which may include red herring conclusion confidence levels) and argument item sequencing information. The critical thinking application authoring tool 115 and the archetype module 120 can ensure that the input data 110 conforms to the archetype. In some embodiments, the multi-media objects in the investigation scenes can include digital multimedia content such as an image, an audio clip, a video clip, a document, an animation, tactile output, graphics, etc. In some embodiments, the scene IDs, hypotheses, evidence items, inferences, conclusions, conclusion confidence levels, hints, red herrings and feedback data can be text phrases.

The user 165 can provide a solution to the problem in the form of hypotheses and arguments supporting or falsifying the hypotheses. The solution may be stored in the solution report 175. Upon completion, the critical thinking application 170 can analyze the solution report 175 and generate a score for the solution for the user 165. Optionally, the user 165 can also obtain feedback about the arguments submitted.

In some embodiments, the components illustrated in FIG. 1 can be implemented using software programming languages such as Java, C++, Perl, HTML, JSP, etc., or using software applications such as form based software applications, including Microsoft Excel.

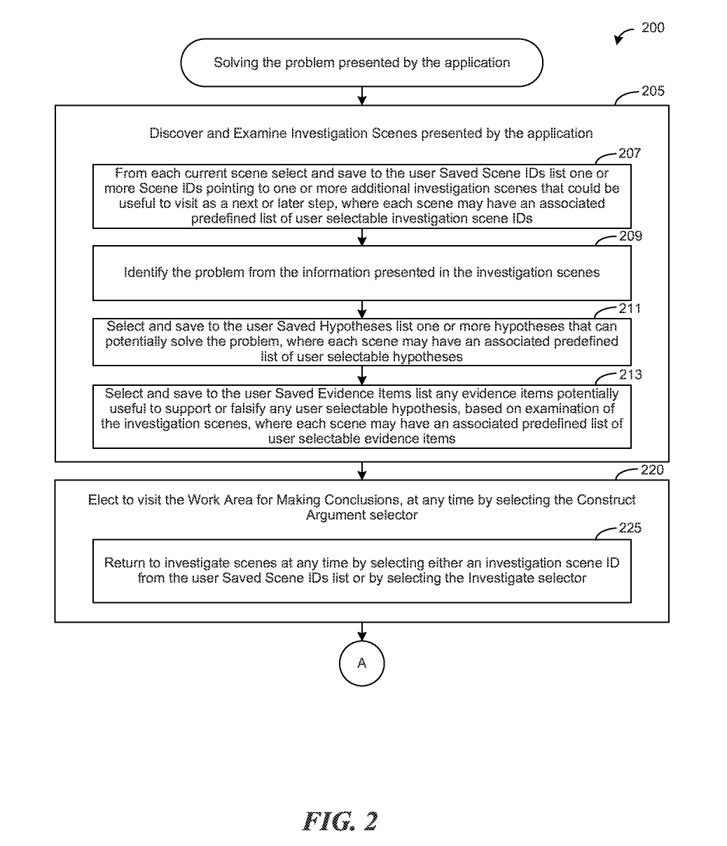

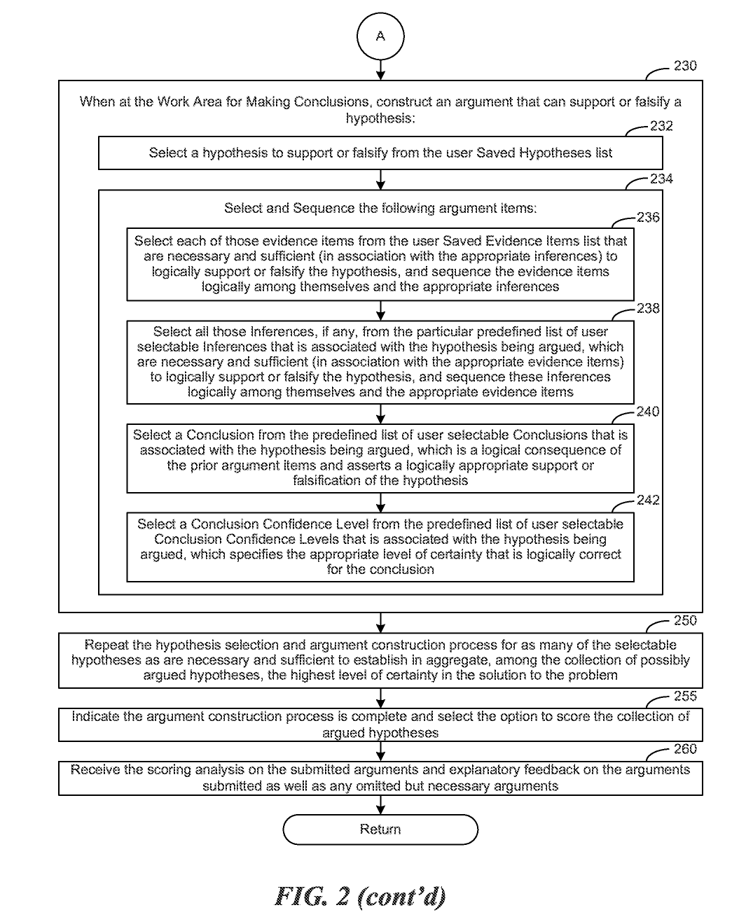

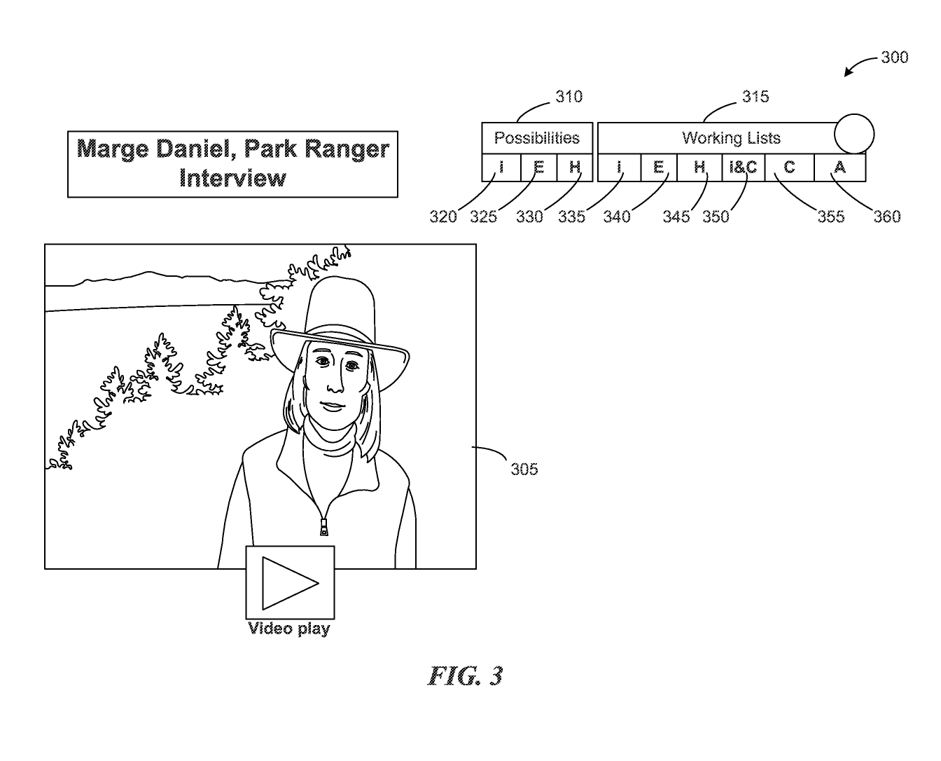

FIG. 2 is a flow diagram illustrating a process for solving a problem presented by a critical thinking exercise, according to an embodiment consistent with the disclosed technique. In some embodiments, the process 200 can be implemented in an environment such as environment 100 of FIG. 1 and the critical thinking exercise can be generated through execution of a critical thinking application such as critical thinking application 170. The critical thinking exercise presents the user with an option to view a number of investigation scenes. At step 205, the user discovers and examines the investigation scenes presented by the critical thinking exercise. In some embodiments, the investigation scenes can include digital multimedia content such as an image, an audio clip, a video clip, a document, text, an animation or a graphic. The user observes and analyzes one or more investigation scenes, seeking additional investigation scenes to visit and observe 207, seeking relevant information and developing an understanding in order to identify the problem 209 and specify one or more hypotheses 211 that might explain the problem (that is, solve the problem) presented by the critical thinking exercise. In some embodiments, the user may select and save one or more investigation scene IDs presented in association with the investigation scene the user is examining 207, enabling the user to save and use a list of investigation scenes to visit and investigate. In some embodiments, the investigation scene IDs are text phrases. Further details regarding presenting the investigation scene IDs in association with a scene are described at least with reference to FIGS. 3 through 13.

At step 211, the user selects one or more hypotheses that might explain the problem presented by the critical thinking exercise. In some embodiments, the user may select and save one or more hypotheses by selecting a particular hypothesis presented in association with the investigation scene the user is examining. In some embodiments, the hypotheses may be presented to the user as text phrases. Further details regarding presenting the hypotheses in association with a scene are described at least with reference to FIGS. 3 through 13.

At step 213, the user gathers pertinent evidence items to help support or falsify any of the user selectable hypotheses. In some embodiments, the user may select and save one or more evidence items based on the understanding gained from examining the scenes. Some evidence items may be presented directly in the investigation scene, or instead some evidence items may be logically derivable from one or more items presented in a particular investigation scene. The user may select and save evidence items presented in association with the investigation scene the user is examining, or may select an evidence item presented in the form of an inference from an inferences and conclusions list (which are described below). In some embodiments, the evidence items may be presented to the user as text phrases. Further details regarding presenting the evidence items in association with a scene are described at least with reference to FIGS. 3 through 13.

Further, while gathering evidence items and analyzing the investigation scenes, the user may identify additional scenes that may be useful to investigate. In various embodiments, the user controls the path of the investigation by navigating to the scenes that the user selects, such as by using investigation scene IDs at step 207. The user may at any time choose to begin constructing arguments to support or falsify particular hypotheses by navigating to the Work Area for Making Conclusions at step 220. The user can freely migrate back and forth between the argument construction process and the investigation of scenes process by selecting appropriate navigational selectors at step 220 and 225.

The critical thinking exercise is solved when the user correctly supports or falsifies all of the pertinent hypotheses with arguments (all as prescribed by the application author). A pertinent or productive hypothesis (both of which shall have the same meaning) is a hypothesis that when either supported or falsified, decreases the uncertainty in the overall conclusion about the problem's solution. In some embodiments, each argument addresses a particular hypothesis and is a sequence of number of argument items, including: the particular hypothesis; necessary and sufficient evidence items and inferences that together support or falsify the particular hypothesis with a coherent, evidence-based, logical rationale; a conclusion about the particular hypothesis; and a conclusion confidence level that is an assessment of the level of certainty of the conclusion. In some embodiments, a sequence, that is, an order of the argument items may also matter to accuracy of the solution. However, in other embodiments, the order of the argument items may not matter to the accuracy of the solution. As described above, the investigation scenes, hypotheses, evidence items, inferences, conclusions, conclusion confidence levels, and argument constructions are provided or defined by the application author as are each of the predefined lists of user selectable items associated with each investigation scene (e.g., the Scene IDs lists, Evidence Items lists, and Hypotheses lists), as well as each of the predefined lists of user selectable items associated with each user selectable hypothesis (e.g., Inferences lists, Conclusions lists, and Conclusion Confidence Levels lists).

Referring back to FIG. 2, at step 230, the user constructs an argument in the Work Area for Making Conclusions 220 based at least in part on the analysis of the investigation scenes 205 the hypotheses selected and saved into the Saved Hypotheses list 211 and the evidence items gathered and saved in the user Saved Evidence Items list 213. The user can construct the complete argument by selecting a hypothesis to argue 232 and then selecting and sequencing a set argument items in the following way. At step 236 the user selects each of those evidence items from the user Saved Evidence Items list that are necessary and sufficient (in association with the appropriate inferences) to logically support or falsify the hypothesis, and sequence the evidence items logically among themselves and the appropriate inferences. At step 238, the user selects all those Inferences, if any, from the particular predefined list of user selectable Inferences that is associated with the hypothesis being argued, which Inferences are necessary and sufficient (in association with the appropriate evidence items) to logically support or falsify the hypothesis, and sequence these Inferences logically among themselves and the appropriate evidence items. Each useful inference is a logical consequence of preceding evidence items and inferences.

At step 240, the user selects a conclusion from the predefined list of user selectable Conclusions that is associated with the hypothesis being argued, which selected Conclusion should be a logical consequence of the preceding argument items and should assert a logically appropriate support or falsification of the hypothesis. At step 242, the user selects a Conclusion Confidence Level from the predefined list of user selectable Conclusion Confidence Levels that is associated with the hypothesis being argued, which selected Conclusion Confidence Level should specify the appropriate level of certainty that is logically correct for the conclusion. In some embodiments, the user may order the argument items in any particular order the user may see it as appropriate. The user may repeat the hypothesis selection and argument construction process 250 for as many of the selectable hypotheses as the user deems necessary and sufficient to establish in aggregate, among the collection of possibly argued hypotheses, the highest level of certainty in the solution to the problem. Upon completion 255, the user indicates the argument construction process is complete and selects the option to score the collection of argued hypotheses.

At step 255, the user submits his/her final set of hypotheses and argument constructions (the solution report) which includes one or more user selected hypotheses and an argument that supports or falsifies each of the one or more user selected hypotheses of the critical thinking exercise. At step 260, the user receives a score report containing a score for the solution. In some embodiments, the score can be in the form of a percentage value, number of points, a grade, segmented predefined categories etc. In some embodiments, the scoring can also be generated per type of argument item. For example, a score can be generated for an inference argument item, which can be based on number of correct inferences included, excluded, etc. A variety of scoring techniques can be implemented. The score report can also include comparisons of a number of users who have solved the critical thinking exercise.

Additionally or alternatively, the user can also receive explanatory qualitative feedback about the solution (e.g., the hypotheses selections made and each argument item of each hypothesis' argument construction). In some embodiments, the qualitative feedback can include description about each hypothesis, each argument and every argument item, explaining the rationale for inclusion of the correct items, the rationale for why omitted items should have been included, and the rationale for why erroneously included items should not have been included.

During the course of solving the problem, the user can ask for hints when investigating scenes, constructing an argument, or after either stage. In some embodiments, a hint may be associated with a cost of points which can affect the score of the user. The critical thinking exercise enables the user to decide on whether to take a hint, depending upon it's point cost. The hint offered can be context dependent (i.e., using the current position and progress of the user, the user's collection of argument items saved, and prior hints provided). The score is adjusted based on the number and point cost of the hints used by the user.

The critical thinking application authoring tool facilitates the application author to include the hints in the critical thinking exercise. The application author decides the types of hints that can be provided for the critical thinking exercise. The hints can include information about (i) necessary hypotheses and evidence items, (ii) the argument construction strategy associated with a particular hypothesis, (iii) necessary argument line items in various arguments, and other help to the user. The critical thinking application also develops at run time, hints that can help, including hints about extent of the current state of progress of the user, remaining undiscovered pertinent hypotheses and necessary evidence items, the total number of items still missing, references to scenes where users need to save a necessary hypothesis or evidence item, and argument sequencing help, for example.

The user can ask for a hint at each scene, and if the application author has included hints, the critical thinking application can manage the provision of such hints depending upon hints already provided and/or the current state of the progress of the user. The hints can include: (i) the number of pertinent hypotheses in the scene, (ii) assisting the user with identifying one or more pertinent hypotheses associated with the scene, (iii) the number of pertinent evidence items in the scene, (iv) the total number of pertinent hypotheses in the critical thinking exercise, (v) the total number of pertinent hypotheses remaining to be identified.

Before beginning to construct arguments, the user may wish to ascertain whether all the pertinent hypotheses and evidence items have been identified. The critical thinking application may also provide such hints. In some embodiments, these hints can include: (i) number of pertinent hypotheses and evidence items that should have been identified, (ii) number of hypotheses missing and remaining to be correctly identified by user, (iii) number of evidence items in total and/or per each particular hypothesis, (iv) number of evidence items that are missing (in total and/or per particular hypothesis), (v) name of one or more individual scenes where at least one hypothesis can be identified, (vi) and name of one or more individual scenes where at least one evidence item can be identified, (vii) the specific number of hypotheses and evidence items at each named scene.

The user may elect to solicit hints about a specific hypothesis and its associated argument, or about the state of completion of all the hypotheses selections and argument constructions. Such hints can include (i) the number of pertinent hypotheses associated with the critical thinking exercise (i.e., the number of unique arguments the user must make to solve the critical thinking exercise), (ii) qualitative description of each pertinent hypothesis, (iii) name of at least one scene that provides the means to select the hypothesis, (iv) a qualitative description of the argument that needs to be made to support or falsify a particular hypothesis, (v) the combined number of evidence items and inferences associated with all the arguments, or the number of those items that are associated with each specific argument, or the number of those items, called out by type of the argument item (i.e., evidence, inferences, conclusions, confidence levels etc.), (vi) hint pertaining to each argument item comprising the applicable logical argument, (vii) source of the argument item, (viii) a faux score covering the full collection of all the arguments, without detailing particulars, and then with increased detail to help the user to focus on those arguments needing attention, (ix) a faux score of each particular argument, without detailing the particulars, and then with increasing detail to help the user to focus on those specific argument line items and/or sequencing issues needing attention.

The hints may permit the user, to incrementally, with assistance, construct the arguments and solve the entire critical thinking exercise, though at a cost of points which could significantly impact the score if much assistance is sought.

Additional details regarding the critical thinking application, the archetype of the critical thinking application and the features of the critical thinking exercise are described at least with reference to FIGS. 3 through 13.

FIG. 3 shows an example of a screen display that may be output to the user by the critical thinking application, to present an investigation scene of a critical thinking exercise, according to an embodiment consistent with the disclosed technique. The examples illustrated in FIGS. 3 through 13 are of a critical thinking exercise related to an investigation of missing fish. The example 300 includes an investigation scene 305, which is a video clip of an interview with a “Park Ranger.” The investigation scene 305 can include information regarding the problem, potential hypotheses, items of evidence, and references to other scenes to be investigated, all of which may helpful to the user in finding a solution to the problem.

An investigation scene can include a multimedia content that can be comprised of digital media such as a still image, a video clip, an audio clip, a graphic, a document, text, an animation, tactile output, etc. In some embodiments, the investigation scene 305 can be associated with a “Potential Items Lists” or “Possibilities Lists” 310 and a “Working Lists” 315. The Potential Items Lists 310 includes a (1) “Potential Investigations List” 320 containing for each scene, a particular predefined list of user selectable and savable Scene IDs pointing to other possible investigation scenes that the user can navigate to, (2) “Potential Evidence List” 325 containing for each scene, a particular predefined list of user selectable and savable potential evidence items, and (3) “Potential Hypotheses List” 330 containing for each scene, a particular predefined list of user selectable and savable potential hypotheses. Each scene has these three lists, and each particular list of each list type is specifically populated for and associated with a particular investigation scene by the author, even though some of the lists can be empty and some of the lists can be the same from scene to scene if so specified. In some embodiments, some or all of these three list types can be aggregated, or some of the lists of the same type can be aggregated across multiple investigation scenes. In some embodiments, each of the three lists contains list items comprised of text phrases describing the corresponding entity. In some embodiments, each of the three lists may include helpful as well as red herring entries. For example, a Potential Hypotheses List 330 can include a list of text phrases describing possible solutions to the problem, some of which may be productive and some of which may not be.

The “Working Lists” 315 can include: (i) “Investigations of Interest” list 335 (also referred to as the “Saved Scene IDs” list) containing a list of investigation scene IDs which the user identified as scenes of interest to investigate, and which is populated by the user adding scene IDs from the various Potential Investigations Lists 320 of various investigation scenes. In some embodiments, the Investigations of Interest list 335 can also include scenes that have been accessed by the user when navigating directly from a Potential Investigations list 320. The “Working Lists” 315 can further include (ii) “Hypotheses to Conclude” list 345 (also referred to as the “Saved Hypotheses” list) containing user selectable hypotheses that are of particular interest to the user for possibly being helpful in solving the problem, where the list can be populated by the user adding hypotheses from the various Potential Hypotheses lists 330 of various investigation scenes, (iii) “Evidence Collected” list 340 (also referred to as the “Saved Evidence Items” list) containing user selectable evidence items gathered by the user at various investigation scenes for use in constructing evidence-based arguments, which list can be populated by the user adding evidence items from various Potential Evidence lists 325 of various investigation scenes.

Additional Working Lists 315 can include (iv) “Inferences and Conclusions” list 350 containing a particular list of user selectable inferences and conclusions that are associated with a particular hypothesis being argued, some of which may or may not be useful for constructing the particular hypothesis' argument (and noting that the inferences and conclusion list 350 is combined for convenience in this embodiment, but in other embodiments can be organized as separate lists, such as a list for inferences and a list for conclusions, or even aggregated or disaggregated in other ways, as long as the particular inferences that are associated with a particular hypotheses and the particular conclusions that are associated with a particular hypothesis appear to the user when he/she is constructing an argument supporting or falsifying that particular hypothesis to which the inferences or conclusions are associated), (v) “Confidence Level” list 355 containing a particular list of user selectable conclusion confidence levels associated with a particular hypothesis being argued, and (vi) “Arguments (Saved Arguments)” list 360 containing a list of all the arguments as currently constructed by the user, which in this embodiment appears as an individual list, but in other embodiments can be combined with other appropriate lists, such as with the Saved Hypothesis list 345, whereupon selecting a particular hypothesis appearing on that list of hypotheses, the user could elect view the currently constructed argument supporting or falsifying it.

From the user's perspective, the Inferences and Conclusion list 350, the Conclusion Confidence Levels list 355, and the Arguments list (Saved Arguments) 360 are not relevant during the scene investigation activity; these 3 lists are appropriately populated and active when the user enters the Working Area for Making Conclusions as their purpose is in the support of argument construction. As such, in certain embodiments, these list selectors will not appear during the investigation of a scene but only in the argument construction screens.

The user can navigate through the various scenes using each scene's “Potential Investigations List” 320 as the source of new scenes, and potentially saving from each visited scene's Potential Investigation List 320 other list Scene IDs that appear useful to be investigated, saving them to the Saved Scene IDs list 335 as a means to organize and execute the scene navigation process. Further, while at each scene, to investigate (e.g., view, listen, and analyze), understand the problem, form ideas about the solution, and save at each particular investigation scene the potential hypotheses and evidence items from that scene's particular “Potential Hypotheses List” 330 and “Potential Evidence List” 325 into the user's “Hypotheses to Conclude” (i.e., Saved Hypotheses) list 345 and “Evidence Collected” (i.e., Saved Evidence) list 340, respectively, for the user to later use to specify productive hypotheses to argue and to apply evidence in the arguments supporting or falsifying the hypotheses. In some embodiments, the user can form arguments during the Conclude Arguments stage by selecting and sequencing text phrases representing the (a) hypotheses saved in the “Hypotheses to Conclude” list 345, (b) evidence items saved in the “Evidence Collected” list 340, (c) inferences and conclusions in the “Inferences and Conclusions” list 350 and (d) conclusion confidence levels in the “Conclusion Confidence Levels” list 355.

In some embodiments, the list items (e.g., text phrases) in each of the Potential Items lists 320, 325, and 330 are dependent on the investigation scene being accessed by the user. That is, the Potential Items list items, or at least some of the list items, may change when the user navigates from one scene to another. However, the list items of the lists 335, 340, 345, 350, 355 and 360 are independent of the investigation scene accessed by the user. 335, 340, and 345 are the user “Working Lists” populated by the user by saving the applicable desired items from each investigation scene's Potential Items lists 320, 325, and 330 during the investigation of each particular scene. These lists, 335, 340, and 345 remain constant unless items are added to or deleted from by the user, and the lists are available to the user during both the scene investigation and the construct argument stages. During the construct argument stage: user “Saved Hypotheses” 345 is the source of hypotheses from which the user selects to begin a new argument construction in support or falsification of that hypothesis; user “Saved Evidence” 340 is the source of evidence items from which the user selects to apply an evidence item into an argument, and user “Saved Scene IDs” 335 contains all of the user's saved or previously visited investigation scene IDs, enabling the user to jump back to investigate any scene on that list at any time, including when in the middle of constructing an argument.

Lists 350, 355, and 360 are different from the other lists, they are related to the constructing arguments stage only, and are not used during a scene investigation and therefore are not populated with anything useful during the investigation of any scene. In some embodiments, lists 350, 355, and 360 appear only during the Construct Arguments stage and not during the investigation of a scene. During the construct argument stage, “Inferences and Conclusions” list 350 is the source of all the possible particular inferences and conclusions that can be used in the particular argument supporting or falsifying a particular hypothesis. The inference items and the conclusion items appearing on each particular Inference and Conclusion list are associated with a particular hypothesis, and the list contents can change when the user selects a different hypothesis to argue. The same is true for the Conclusion Confidence Level list, it provides the user with a source of conclusion confidence levels to select from to complete an argument, and the contents of this list are associated with a particular hypothesis which contents can change when the user selects another hypothesis.

In some embodiments the Inference lists 350a (shown aggregated as 350), Conclusion lists 350b (shown aggregated as 350) and Conclusion Confidence Level lists 355 can be maintained as 3 separate lists or be aggregated in any combination of lists, although the contents of any of these 3 lists may change with each different particular hypothesis. The Arguments list 360 maintains the current state of user constructed arguments, and changes only when the user changes an item pertaining to one of his/her constructed arguments or begins a new argument with another hypothesis. In different embodiments, this list 360 can be aggregated with Saved Hypotheses 345, where the list of Hypotheses can be shown to the user whereupon the user can elect to see the remainder of a particular hypothesis' argument from that list. Each of the lists mentioned above are described in further detail in the following paragraphs.

### 1. Potential Investigations List

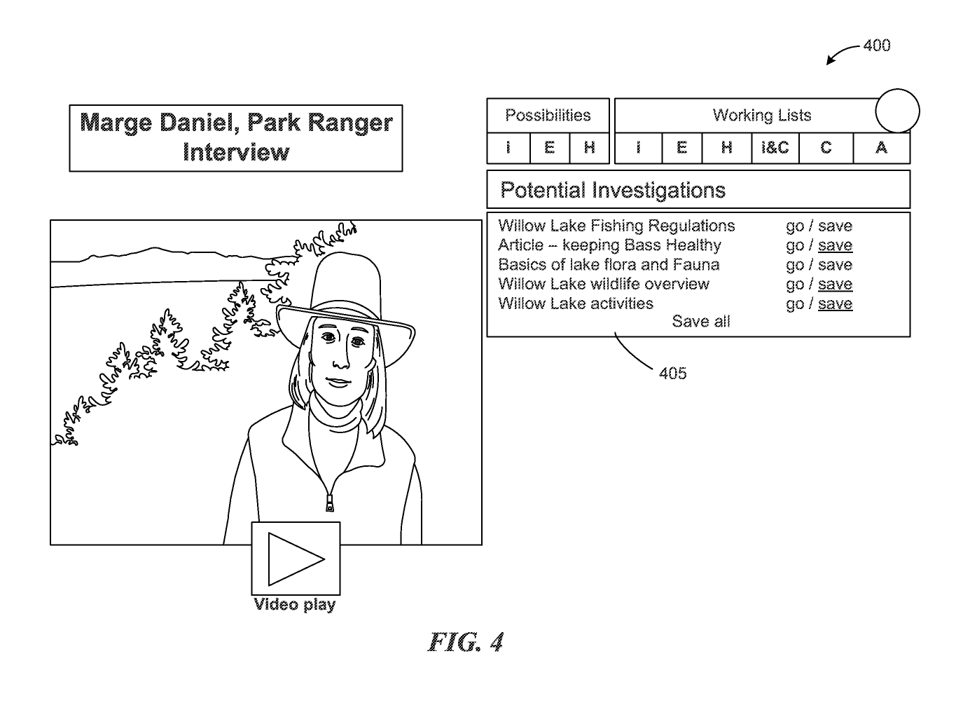

Associated with each scene is the scene's own specific potential investigations list. FIG. 4 is an example 400 of “Potential Investigations” list 405 of an investigation scene 305 of FIG. 3, according to an embodiment consistent with the disclosed technique. The application author specifies (predefines) particular user selectable scene IDs to be on a particular scene's “Potential Investigations List” 405. When the user is investigating a particular scene, the user can view that scene's particular predefined Potential Investigations List 405, and make a determination about which, if any, of the user selectable listed scene IDs appear to be interesting to access and investigate. The user can either navigate directly to a scene ID on the list, or save one or more of the list's scene IDs to the users' Saved Scene ID list for later access.

When the user moves to another investigation scene, a new particular predefined Potential Investigation list 405 associated with the new scene will be available to view (which new Potential Investigations list 405 may or may not contain any or all of the same Scene IDs from the Potential Investigations list 405 of the prior investigation scene). In some embodiments, some of the investigation scenes may have a “restricted reveal” constraint in which case the user is required to interact with the scene in a particular manner, such as zooming in on a particular portion of the multi-media object in order to reveal the “restricted” items on the particular scene's Potential Investigations list 405. When the restricted reveal condition is met (such as zooming in on a particular segment of the media object), all the applicable restricted Scene IDs are revealed and selectable by the user.

In some embodiments, some of the investigation scenes in the “Potential Investigations List” 405 can be “red herring” scenes which are scenes that either mislead the user from the actual solution of the problem, or are not useful for solving the problem.

### 2. Potential Hypotheses List

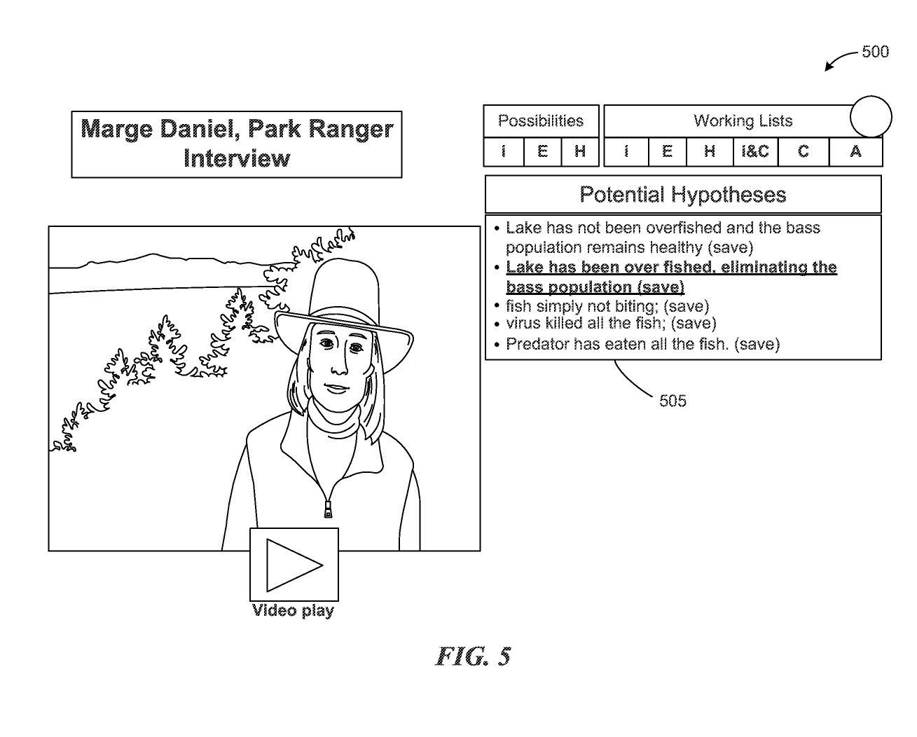

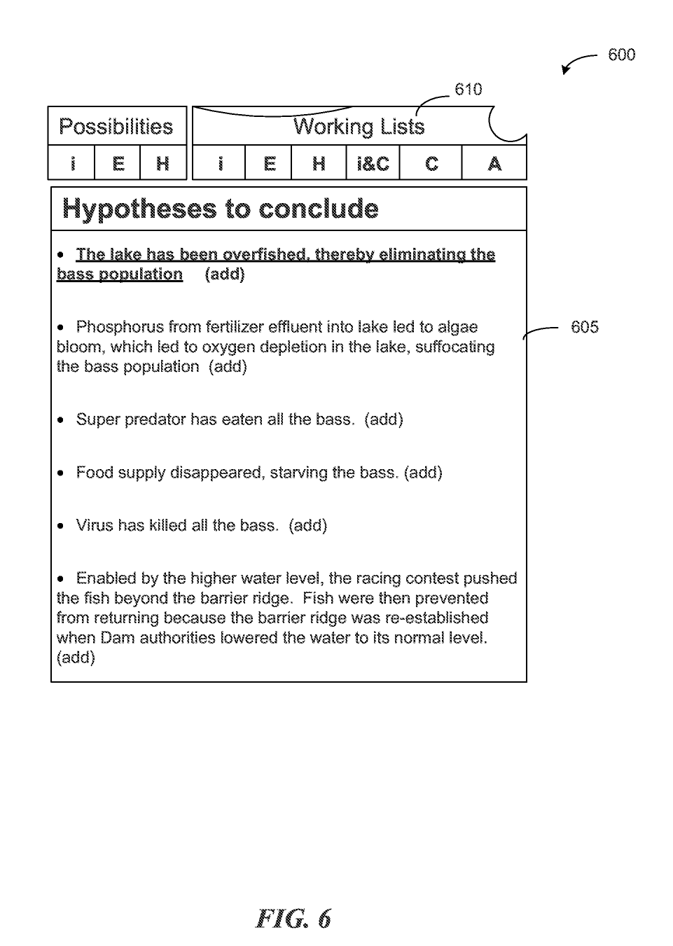

Each scene has associated with it, its own specific potential hypotheses list. FIG. 5 is an example 500 of a “Potential Hypotheses” list 505 of an investigation scene 305 of FIG. 3, according to an embodiment consistent with the disclosed technique. The application author specifies (predefines) any particular user selectable hypotheses on a particular scene's “Potential Hypotheses” list 505. When the user is investigating a particular scene, the user can view that scene's particular predefined Potential Hypotheses list 505 and make a determination about which, if any of the user selectable listed hypotheses appear to be potentially productive toward solving the problem. The user can select one or more of the hypotheses listed on that scene's “Potential Hypotheses” list 505 and save it in the users “Hypotheses to Conclude” (Saved Hypotheses) list from which the user can later select the hypothesis to construct a supporting or falsifying evidence-based logical argument. FIG. 6 illustrates an example 600 of a “Hypotheses to Conclude” list 605, according to an embodiment consistent with the disclosed technique. The “Hypotheses to Conclude” list 605 includes hypotheses that are added by the user from various particular Potential Hypotheses Lists 505 associated with various particular investigation scenes. When the user moves to another investigation scene, a new particular predefined Potential Hypotheses list 505 associated with the new investigation scene will be available to view (which new Potential Hypotheses list 505 may or may not contain any or all of the same hypotheses from the Potential Hypotheses list 505 list of the prior investigation scene).

The “Potential Hypotheses” list 505 can also include “red herring” hypotheses which are hypotheses that either mislead the user from the actual solution of the problem or are not useful for solving the problem.

In some embodiments, some of the investigation scenes may have a “restricted reveal” constraint in which case the user is required to interact with the scene in a particular manner, such as zooming in on a particular portion of the multi-media object in order to reveal the “restricted” items on the scene's Potential Hypotheses list 505. When the restricted reveal condition is met (such as zooming in on a particular segment of the media object), all the applicable restricted Potential Hypotheses 505 are revealed and selectable by the user from the applicable Potential Hypotheses list 505.

### 3. Potential Evidences List

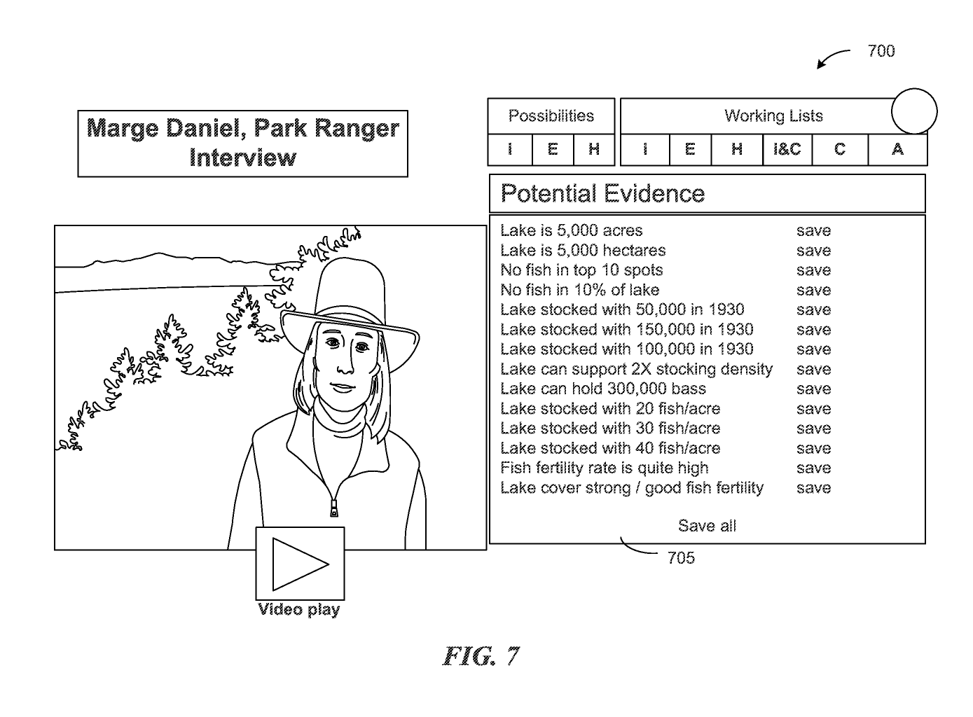

Each scene has associated with it, its own specific potential evidences list. FIG. 7 is an example 700 of a “Potential Evidence” list 705 of an investigation scene 305 of FIG. 3, according to an embodiment consistent with the disclosed technique. The application author specifies (predefines) any particular user selectable evidence items on a particular scene's “Potential Evidences” list 705. When the user is investigating a particular scene, the user can view that scene's particular predefined Potential Evidences list 705 and make a determination about which, if any of the user selectable listed evidence items appear to be potentially helpful toward supporting or falsifying a hypothesis. The user can select one or more of the evidence items listed on that scene's “Potential Evidences” list 705 and save it in the users “Saved Evidence” list from which the user can later select any of the saved evidence items for use in an argument supporting or falsifying a hypothesis.

When the user moves to another investigation scene, a new particular predefined Potential Evidences list 705 associated with the new investigation scene will be available to view (which new Potential Evidences list 705 may or may not contain any or all of the same evidence items from the Potential Evidences list 705 of the prior investigation scene). In some embodiments, evidence items appearing on the Potential Evidences list 705 will be plainly apparent from the information provided in the scene, and sometimes the evidence items will be logically derivable from information on the scene. Further, the “Potential Evidence” list 705 can include “red herring” evidence items which are evidence items that either mislead the user from the actual solution of the problem, or are not useful for solving the problem.

In some embodiments, some of the investigation scenes may have a “restricted reveal” constraint in which case the user is required to interact with the scene in a particular manner, such as zooming in on a particular portion of the multi-media object in order to reveal the “restricted” items on the scene's Potential Evidence list 705. When the restricted reveal condition is met (such as zooming in on a particular segment of the media object), all the applicable restricted Potential Evidence Items are revealed and selectable by the user from the applicable Potential Evidences list 705.

In some embodiments, since the hypotheses and the evidence items are associated with specific investigation scenes, the user may have to visit/investigate appropriate scenes in order to at least (a) select appropriate hypotheses that may explain the solution to the problem and (b) discover appropriate evidence items that may be necessary to support or falsify the selected hypotheses.

### Investigations of Interest List (Also Referred to as Saved Scene IDs)

Referring back to FIG. 3, the “Investigations of Interest” (Saved Scene IDs) list 335 is the user's repository for all scene IDs that the user saves from the various potential investigations lists of various scenes, such as “Potential Investigations” list 405. These saved scene IDs are the scenes that the user has identified as interesting to visit. The user can use the “Investigations of Interest” (Saved Scene IDs) list 335 to recall any of those scenes the user wants to visit while conducting the investigation or to revisit during the construction of an argument.

### Hypotheses to Conclude List (Also Referred to as Saved Hypotheses)

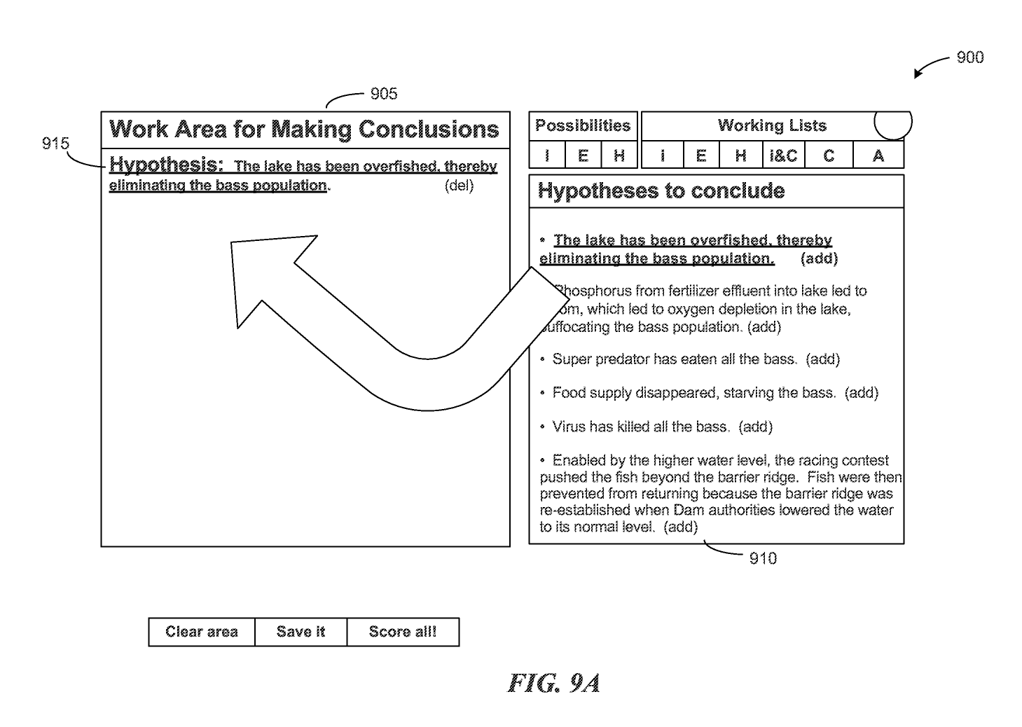

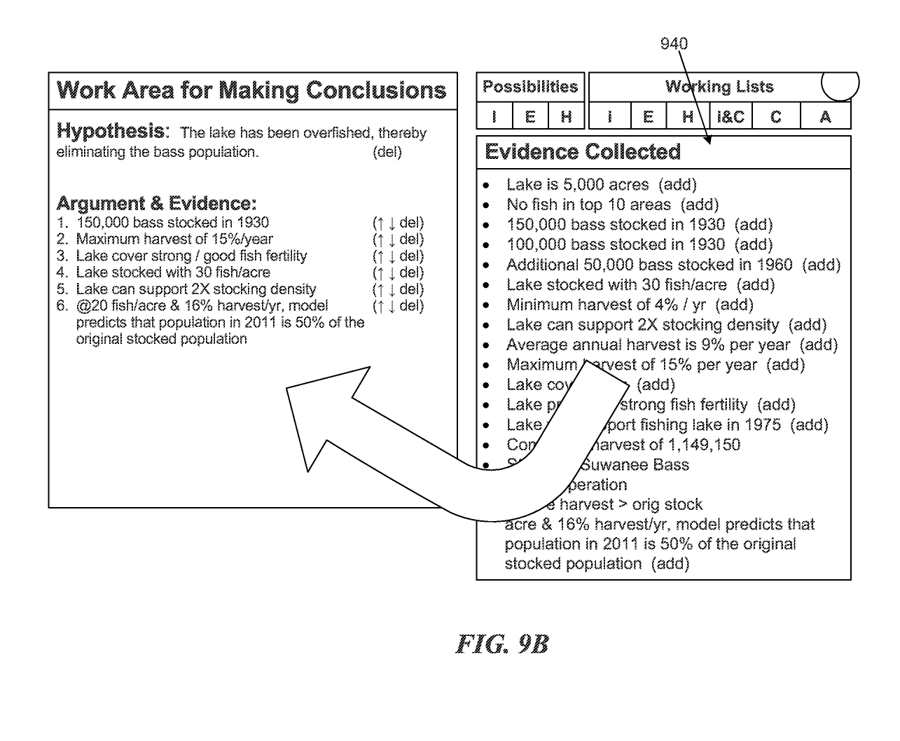

Referring back to FIG. 3, the “Hypotheses to Conclude” (Saved Hypotheses) list 345 is the repository all hypotheses that the user saves from the various potential hypotheses lists of the various investigation scenes, such as “Potential Hypotheses” list 505. The user saves various of these hypotheses from the investigation scenes because the user believes that each may be productive in advancing the solution to the problem; that is, after each of the potentially productive hypotheses is supported or falsified with a logical evidence-based argument, the collection of such properly supported or falsified hypotheses can provide the best solution to the problem. As such, once the Hypotheses to Conclude (Saved Hypotheses) list is populated with at least one hypothesis, it also serves as the repository from which the user selects a hypothesis to support or falsify. Referring to FIG. 9, during argument construction, the user selects a hypotheses (one per argument formation) that the user deems productive from the Hypotheses to Conclude (Saved Hypotheses) list 910 and places it in the “Work Area for Making Conclusions” (905) to begin the argument construction process for that particular hypothesis.

### Evidence Collected Working List (Also Referred to as Saved Evidence Items)

Referring back to FIG. 3, the “Evidence Collected” (Saved Evidence Items) list 340 is the user's repository for all the evidence items that the user believes relevant and valid, and thus has saved from various “Potential Evidence” lists of various scenes. Referring to FIG. 9B, once populated with at least one saved evidence item, the Evidence Collected (Saved Evidence Items) list 940 also serves as the repository for all the evidence items from which the user can select to place and use in any argument he/she is constructing in order to support or falsify a particular hypothesis.

### Inferences and Conclusions Working List

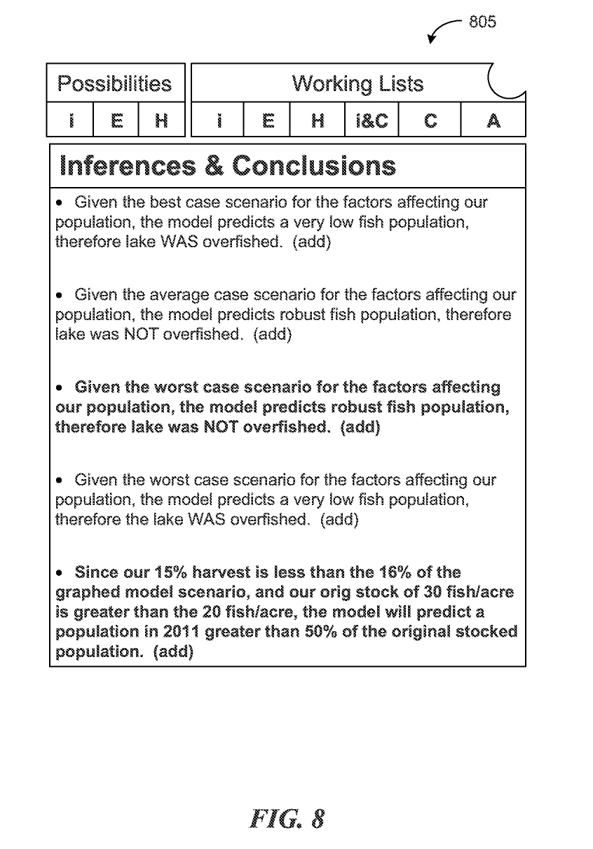

FIG. 8 is an example of an “Inferences and Conclusions” list 805 of a critical thinking application, according to an embodiment consistent with the disclosed technique. The “Inferences and Conclusions” list 805 is an application author provided list that is associated with a particular hypothesis, where each such particular list includes inferences and conclusions that may be needed to support or falsify that particular hypothesis. The inferences and conclusions on the list are user selectable and can be placed as appropriate in the argument the user is constructing. When the user changes the hypothesis being argued, the contents of the Inferences and Conclusion list 805 automatically re-populates with the set of inferences and conclusions associated with the new hypothesis, which may or may not include none, some, or all of the inferences and conclusions associated with the prior hypothesis.

An inference is a statement or phrase that is a logical consequence of the preceding evidence and/or inferences, and may or may not be productive in advancing the support or falsification of its associated hypothesis. A conclusion is a statement or phrase that is a logical consequence of the preceding evidence and/or inferences, and may or may not appropriately assert the support or falsification of its associated hypothesis. In some embodiments, the “Inferences and Conclusions” list 805 can include “red herring” inferences, and red herring conclusions, all of which either mislead the user from the actual solution of the problem, or are not useful for solving the problem. In some embodiments, the Inference phrases and the Conclusion phrases can be organized on two separate lists rather than combined on a single list as shown here, but if on separate lists, would otherwise function similarly as expressed herein. In some embodiments, the Inference list or the Inference and Conclusion list for each particular hypothesis can be presented appended to one or more of the other Working Lists (such as the Collected Evidence (Saved Evidence) list, although the contents of the appended inference list or inference and conclusion list will change as the hypothesis being argued is changed whereas the Saved Evidence list is only changed by the user adding or deleting items from it.

### Conclusion Confidence Level List

Referring back to FIG. 3, the “Conclusion Confidence Level” list 355 is an application author provided list that is associated with a particular hypothesis, where each such particular list includes items that express a level of certainty in an argument's conclusion about the particular associated hypothesis. The Conclusion Confidence Levels expressed on the list are user selectable and can be placed by the user in the appropriate argument location so as to express the level of certainty logically appropriate for the argument conclusion. When the user changes the hypothesis being argued, the contents of the Conclusion Confidence Level list 355 automatically re-populates with the set Conclusion Confidence Levels associated with the new hypothesis, which may or may not include none, some, or all of the Conclusion Confidence Levels associated with the prior hypothesis. The “Conclusion Confidence Level” list 355 can also include one or more “red herrings” which can either mislead the user from the actual solution of the problem, or are not useful for solving the problem. In some embodiments, the Conclusion Confidence Level list could be appended to the Inferences and Conclusions list, or with a Conclusions list that is separate from the Inferences list, or in some other manner, but however aggregated and displayed, would otherwise function similarly as expressed herein.

### Constructing an Argument

FIG. 9A is an example of a work area of the critical thinking application for forming arguments, according to an embodiment consistent with the disclosed technique. After the user has analyzed the investigation scenes, identified and saved the hypotheses to support or falsify (e.g., by saving various hypotheses from the various potential hypotheses lists of various scenes into the user's hypothesis to conclude (Saved Hypotheses) list such as the “Hypotheses to Conclude” list 910), and identified evidence items that may be useful for forming the arguments (e.g., by saving various evidence items from various potential evidence lists of various scenes, into the user's evidences collected (Evidence Saved) list such as “Evidence Collected” list 340), the user may form arguments for some or all of the saved hypotheses.

In some embodiments, the archetype of the critical thinking application requires that an argument supporting or falsifying a particular hypothesis include argument items such as at least one evidence item, a conclusion and a conclusion confidence level. The argument can also include multiple evidence items and/or one or more inferences.

In some embodiments, the user may form an argument using a work area 905 in the critical thinking application. The user can add a hypothesis 915 that the user wants to support or falsify to the work area 905 from the “Hypotheses to Conclude” (Saved Hypotheses) list 910 as illustrated in FIG. 9A. The “Hypotheses to Conclude” (Saved Hypotheses) list 910 is the same user repository of user saved hypotheses as the “Hypotheses to Conclude” list 345 of FIG. 3 or “Hypotheses to Conclude” list 605 of FIG. 6. As illustrated in FIG. 9B, the user may similarly add one or more evidence items from the Evidence Collected (Saved Evidence Items) list 940 that the user believes may be necessary to support or falsify the hypotheses 915 to the work area 905. The “Evidence Collected” (Saved Evidence Items) list 940 is the same user repository of user saved evidence items as the “Evidence Collected” (Saved Evidence Items) list 340 of FIG. 3. Similarly, the user may include one or more inferences in the argument by adding the inferences to the work area 905 from an inferences and conclusion list such as “Inferences and Conclusion” list 350 or “Inferences and Conclusion” 805 of FIG. 5.

Similarly, the user may then conclude the argument by adding a conclusion to the work area 905 from an inferences and conclusion list such as “Inferences and Conclusion” list 350 or “Inferences and Conclusion” 805 of FIG. 5. The user may then specify a conclusion confidence level, that is, a level of certainty of the conclusion, by adding a confidence level to the work area 905 from a conclusion confidence level list such as “Conclusion Confidence Level” list 355.

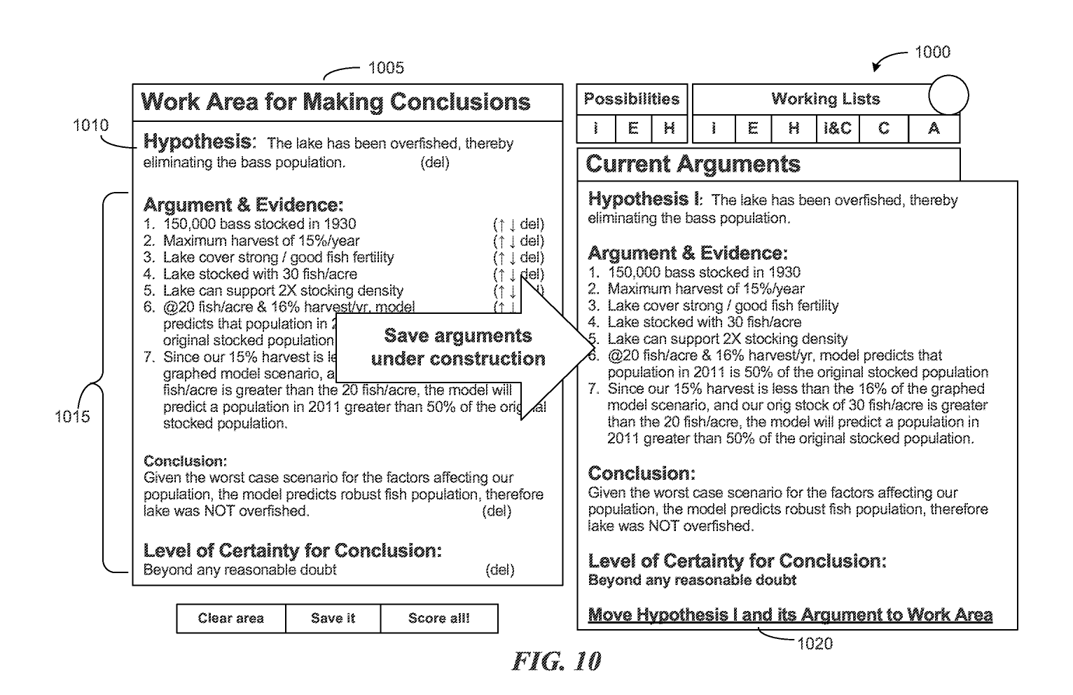

FIG. 10 is an example 1000 of a work area 1005 of a critical thinking application containing a user-selected hypothesis and a user-constructed argument that supports or falsifies the hypothesis to a particular level of confidence, according to an embodiment of the disclosed technique. The work area 1005 includes a hypothesis 1010 which is similar to the hypothesis 915 of FIG. 9A, and an argument 1015, which includes evidence items, an inference, a conclusion and a conclusion confidence level, that falsifies the hypothesis 1010.

After the argument 1015 is formed, the user may submit the argument 1015 for evaluation or save it to the “Arguments (Saved Arguments)” list 1020 for later submission. The “Arguments (Saved Arguments)” list 1020 is the repository for all of the partially or completely constructed arguments. The “Arguments (Saved Arguments)” list 1020 is the same repository for user constructed arguments as the “Arguments (Saved Arguments)” list 360 of FIG. 3. The hypothesis 1010 and its associated argument 1015 are saved in the “Arguments (Saved Arguments)” list 1020 in the same sequence as in the work area 1005. In some embodiments, saving the arguments to the “Arguments (Saved Arguments)” list 1020 enables the user to save all argument construction work, allowing the user to work on other arguments before completing prior ones or even to iterate between investigating scenes and constructing arguments without losing saved argument construction activity. In some embodiments, the user can retrieve the saved arguments from the “Arguments (Saved Arguments)” list 1020 and further modify the argument if the user wishes to. The user may add, delete, or change the order of the argument items. When the user completes the argument 1015, the user can submit the argument 1015 for scoring and review, or continue to construct additional arguments if the user believes that other hypotheses need to be supported or falsified in order to increase the user's level of certainty in the solution to the problem.

### Scoring

The score of the solution provided by the user is determined as a function of the user-identified and selected hypotheses and corresponding user-constructed arguments and the application-author-defined hypotheses and corresponding application-author-defined arguments. The author can define various types of functions to determine a score. In some embodiments, the score is determined by comparing the application-author-defined productive hypotheses against the user-selected productive hypotheses (where each productive hypothesis is one that reduces the uncertainty in the solution to the problem, when it is argued properly), adding score points for hypotheses that match and deducting points for user hypotheses that do not match (by omission or improper inclusion of a red herring hypothesis) and by comparing each of the corresponding application-author-defined arguments against the corresponding user-constructed arguments, argument item by argument item, adding score points for the user-constructed argument item entries that match with application-author-defined argument item entries and subtracting score points for user-constructed argument item entries that do not match (by way of omission or improper inclusion, including the inclusion of red herrings). Points may also be deducted in various amounts for the number and type hints requested by the user.

In some embodiments, the author can specify a function for adding or subtracting the number of points for correct argument items and incorrect argument items, respectively. Further, the number of points can differ between differing for argument item types, for example, the number of points for an evidence item may be different from number of points for an inference. Also, the application author can specify the number of points to be subtracted per red herring item that the user has included in an argument.

In some embodiments, the scoring can also provide points for proper sequencing of the argument items. The user can earn points for each constructed argument when all the necessary and sufficient argument line items (as defined by the application author) are included in the argument by the user, and, then for each such argument, additional points for that argument where the sequence of the argument items are consistent with the application author defined sequence.

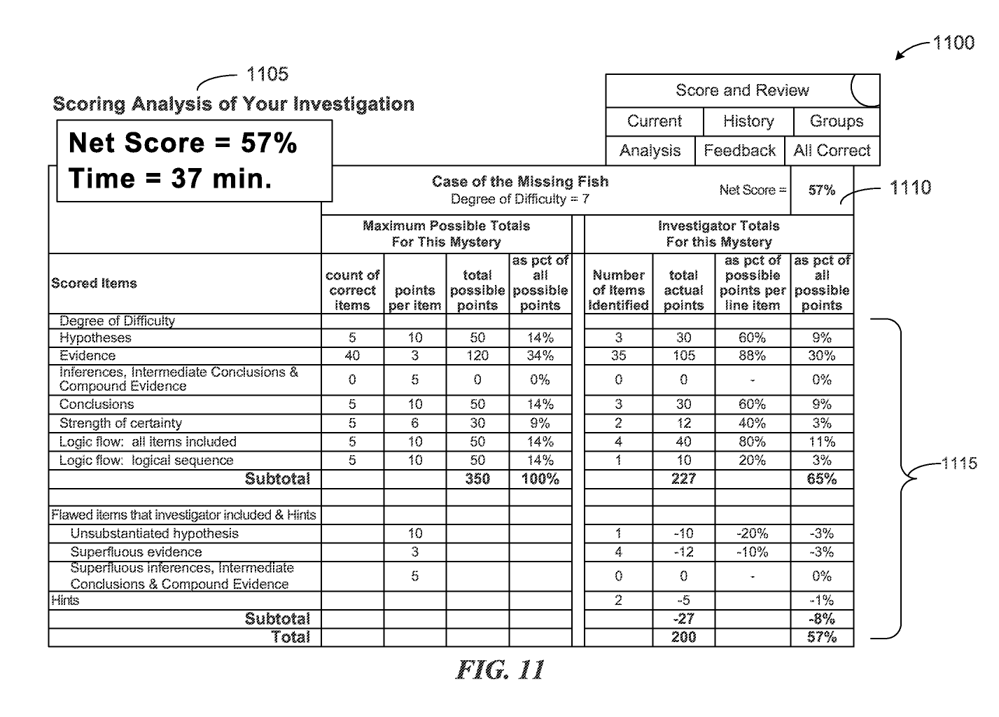

FIG. 11 is an example 1100 of a score report 1105 generated by a critical thinking application, according to an embodiment consistent with disclosed technique. The critical thinking application can generate a score report 1105 providing various performance data, including: (a) an overall score 1110, (b) detail score, subtotaled by type of argument item, by argument completeness, by correct sequencing, and by hint usage as illustrated by each of the rows in 1115. The score report 1105 can also include (none of which are illustrated) (c) a summary of the overall scores for any group of critical thinking exercises that the user has engaged; (d) detailed scoring subtotals (by type of argument item) aggregated for any group of critical thinking exercises that the user has solved; (e) detailed scoring subtotals (by type of argument item) statistically analyzed (including low, high, average and standard deviation) for any group of critical thinking exercises; and (f) detailed scoring subtotals (by type of argument item) trended progressively for any group of critical thinking exercises.

### Feedback

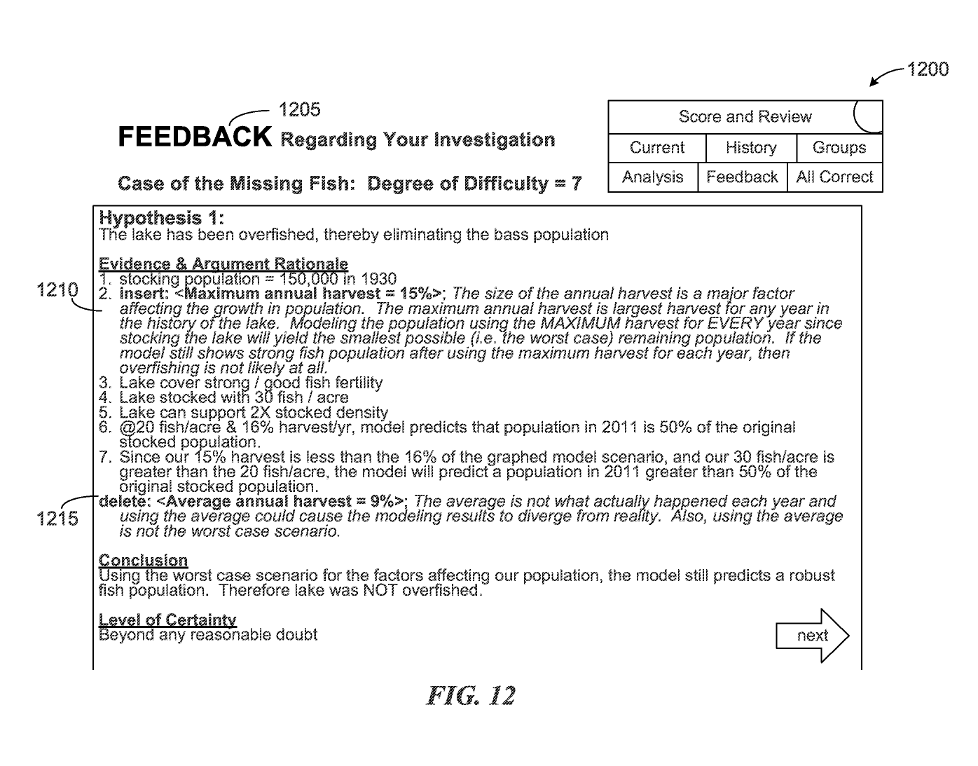

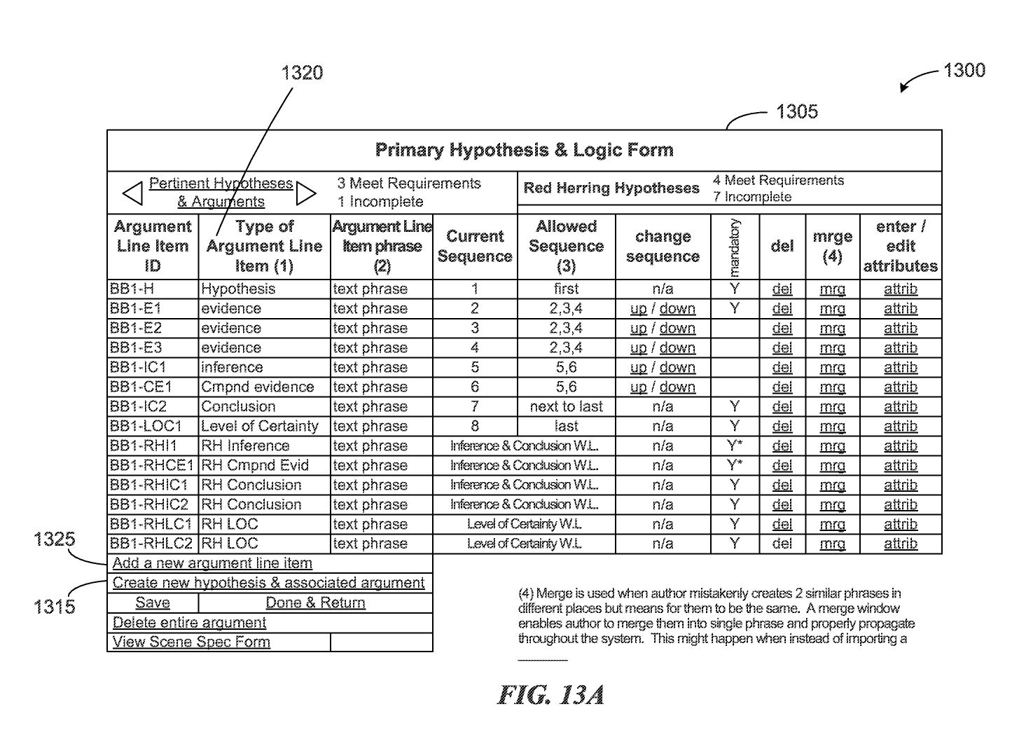

FIG. 12 is an example 1200 of a feedback report 1205 generated by a critical thinking application, according to an embodiment consistent with disclosed technique. The user can also obtain descriptive explanatory corrective feedback about arguments that the user has constructed. For example, the feedback can be that a particular argument item should have been added or should not have been added. The feedback report 1205 can include descriptive explanatory feedback about correct argument items and incorrect argument items. A correct argument item feedback 1210 includes (a) the argument item text phrase and (b) the rationale for why the argument item is necessary. The rationale for why the argument item is necessary field has a text entry by the author in enough detail as to be informative and instructive to the user as to why this argument line item is necessary for making the argument.

An incorrect argument item feedback 1215 (a) the argument item text phrase and (b) the rationale for why the argument item is not appropriate. An incorrect argument item entered by the user can be a red herring which could be an inappropriate hypothesis, evidence item, inference, conclusion, or conclusion confidence level that is not useful for falsifying or supporting the hypotheses to the highest level of certainty nor useful in solving the problem to the highest level of certainty. The rationale for why the red herring item is not appropriate has enough detail as to be informative and instructive to the user as to why its selection is inappropriate.

The feedback report 1205 can also present (a) user constructed arguments, corrected with each incorrect line item highlighted and the inclusion of a description of why the incorrect item is incorrect; (b) the author specified correct line-by-line argument for each pertinent hypothesis; (c) the author specified correct line-by-line argument for each pertinent hypothesis along with a description of why each line-item is appropriate and/or necessary.

### Authoring Tools

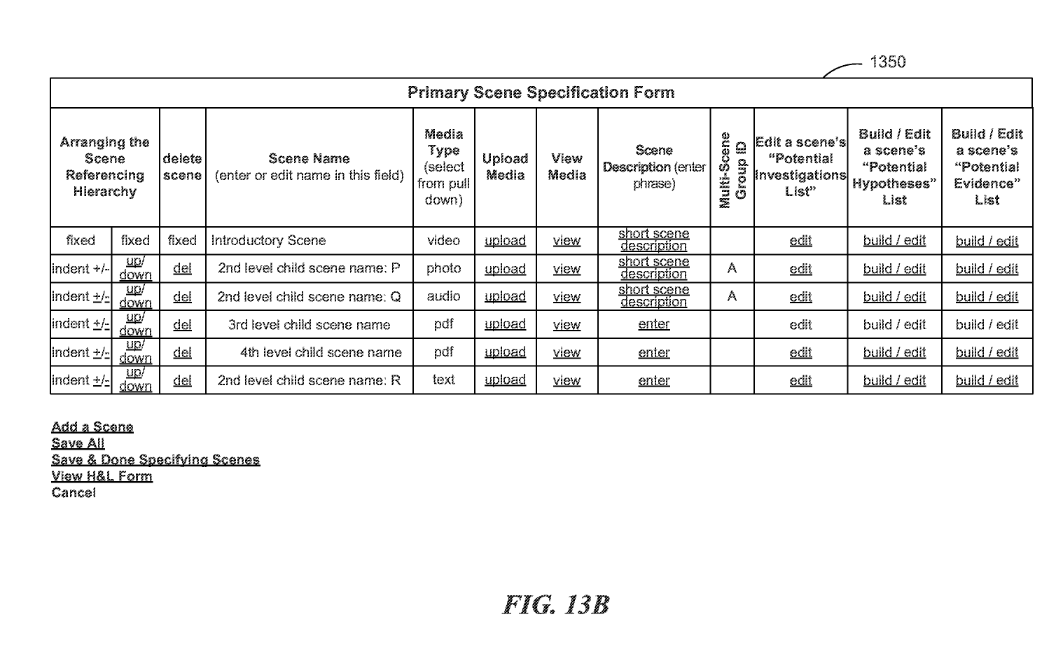

FIG. 13, which includes FIGS. 13A and 13B, is an example of two user interfaces of a critical thinking application authoring tool 1300, according to an embodiment of the disclosed technique. In some embodiments, the critical thinking application authoring tool 1300 is similar to the critical thinking application authoring tool 115 of FIG. 1. An application author uses the critical thinking application authoring tool 1300 to create a critical thinking application that, when executed by a machine-implemented system, generates a critical thinking exercise such as the critical thinking exercise described with reference to FIGS. 3 through 12. The critical thinking application authoring tool 1300 can include a number of user interfaces that can facilitate the application author to create the critical thinking exercise and application. One such user interface is a hypothesis specification form 1305 that is used by the author to specify a hypothesis and its associated supporting or falsifying logic, that is, an “argument.” Another user interface includes a scene specification form 1350 that is used to define investigation scenes of the critical thinking exercise.

The application author can create a new hypothesis and its associated argument by selecting the “Create new hypothesis & associated argument” option 1315. The column “Type of Argument Line Item” 1320 contains various argument items, including hypothesis, evidence items (direct and derived-compound), inference, conclusion, level of certainty of the conclusion (also referred to as “conclusion confidence level”), red herring argument items, etc. as defined by the archetype of the critical thinking application authoring tool 1300. The application author can specify the definition description, that is, text phrases for each of these argument items in the column “Argument line Item phrase.” The application author can continue adding additional argument items, for example, using the “Add a new argument line item” 1325 until all the argument items that are necessary for falsifying or supporting the hypothesis are entered. The means to enter the “type of argument line item” arises (not illustrated) when the application author selects to add a new argument line item, and a secondary form (not illustrated) arises applicable to the addition of each new argument line item, enabling the application author to specify several of the argument item's additional attributes, including for example, a description of how an inference item is derived from preceding argument items, hints pertaining to the argument item's use in the argument, or feedback explaining the use of the argument item in the particular argument).

The application author can also specify the sequence of the argument items using the column “Allowed Sequences.” In some embodiments, the hypothesis specification form 1305 also specifies which of the argument items are mandatory for the application author to complete, using the column designated “mandatory.”

In some embodiments, the hypotheses specification form 1305 is configured to alert the application author if the hypotheses and the associated argument do not conform to the archetype defined by the critical thinking application authoring tool 1300. For example, the hypotheses specification form 1305 may alert the application author if the argument does not include any or less than a minimum number of required red herring argument items.

The scene specification form 1350 can be used to establish new scenes, add scene media, specify the hierarchy of referring scenes, associate evidence items and hypotheses with the scenes, connect scenes in multi-scene groups (for direct navigation between them), etc. The application author can define the scene IDs in the column “Scene Name.” In some embodiments, the scenes can be indented relative to one another to establish each scene as a child scene of another scene. “Children” scenes are the scenes referred to on a particular scene's “Potential Investigations” list. In the scene specification form 1350, the 2nd Level child scenes “P”, “Q” and “R” are the only children of the “Introductory Scene”, and as such, appear on the introductory scene's “Potential Investigations” list (except in the case where the application author has specified that the “restricted reveal” attribute is activated for one or more particular children scenes. In some embodiments, the restricted reveal attribute can be specified for various investigation scenes using a secondary scene specification form (not illustrated). Other data, including, for example, the scene description can be input using the scene specification form 1350.

The application author can also specify for a scene, using the column “Build/Edit a scene's ‘Potential Hypotheses’ List” in the scene specification form 1350, the hypotheses to be included in the particular “Potential Hypotheses” List of the scene. The application author can select the “build/edit” text button for that particular scene, and then specify the particular hypotheses either by importing an already defined hypothesis from the hypothesis specification form 1305, or build a new hypothesis for inclusion on that scene's “Potential Hypotheses” list. A secondary form arises (not illustrated) when specifying the hypotheses to appear on the scene's Potential Hypotheses list, enabling the application author to enter various attributes of each such hypothesis so appearing. The application author can similarly specify the evidence items for the “Potential Evidences” list of the particular scene.

When the author first creates a new hypothesis from the Scene Specification form 1350 rather than importing it from the Hypothesis Specification form 1305, the author must also complete the hypothesis' argument on the Hypothesis Specification form 1305 at some point and the authoring tool will ensure that the author takes that action. Even red herring hypotheses appearing in a scene but which are not productive to be argued, are also specified on the Hypothesis Specification form along with the items that are essential to associate with each hypotheses' argument (i.e., inferences, conclusions, and conclusion confidence levels) so that users will not easily sniff out the red herring hypotheses by simply evaluating their associated inferences, conclusions and conclusion confidence levels when starting to argue that red herring hypothesis. Conversely, when an author specifies a hypothesis or evidence item on the hypothesis specification form 1305, the author tool ensures that the author associates each of those items with at least one scene's Potential Hypothesis list or one scene's Potential Evidence list, respectively in order that the user may discover and save it for use in an argument.

The critical thinking application authoring tool 1300 includes a number of similar user interfaces that facilitates the author to specify any information that may be necessary for a user to solve the problem, including investigation scenes, hypotheses, evidence items (direct and derived-compound), inferences, conclusions, conclusion confidence levels, argument constructions, red herring items, hints, scoring functions, feedback data. FIG. 13 illustrates a form based critical thinking application authoring tool 1300. However, one skilled in the art would recognize that other user interfaces or input means that facilitates an author in inputting data according to the archetype of the critical thinking exercise may be used.

By organizing the creation of the critical thinking exercise and data entry process around arguments and scenes, the critical thinking application authoring tool 1300 facilitates and significantly amplifies the author's clarity, creativity, efficiency and effectiveness. By approaching the critical thinking exercise from the arguments and scenes perspectives, the author is enabled to simplify, clearly visualize, and structure a potentially complex tangle of story, plot, hypotheses, evidence items, inferences, red herrings, scenes, correct argumentation, erroneous argumentation, hints and explanatory rationales.

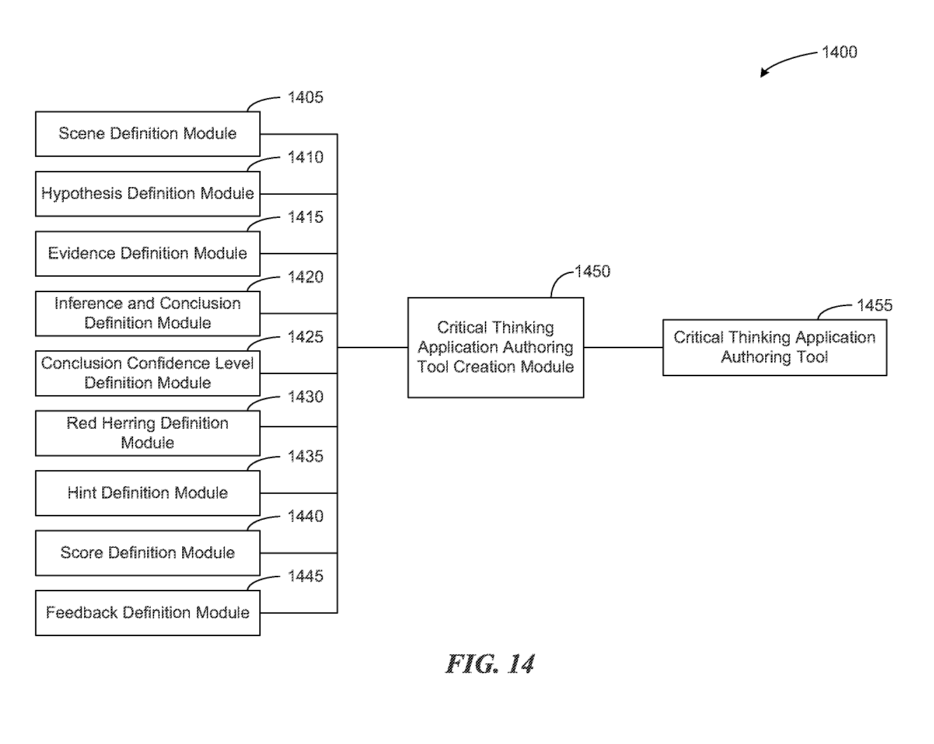

FIG. 14 is a block diagram of a system and technique for creating a tool for authoring a critical thinking application, according to an embodiment of the disclosed technique. In some embodiments, the system 1400 can be used to create a tool for authoring the critical thinking application that provides a critical thinking exercise, such as the critical thinking application authoring tool 1300 of FIG. 13. The system 1400 includes a number of modules that collectively define an archetype of a critical thinking exercise. The scene definition module 1405 generates scene attributes such as a scene ID attribute (e.g., scene name attribute), a referred scenes attribute, a scene multi-media item attribute configured to receive the media object of the scene, a position attribute that is configured to receive from the application author a position on a screen of the device where the scene media should be displayed, and other attributes such as each scene's associated hypotheses and evidences and their attributes for the particular scene. In some embodiments, the scene attributes can include attributes represented by the columns of the scene specification form 1350.

The hypothesis definition module 1410 generates attributes that define a hypothesis and its associated argument (hereinafter simply “hypothesis attributes”). The hypothesis attributes can include a text phrase attribute that is configured to receive, from the application author, the text phrase providing an explanation of a solution to the problem presented by the critical thinking exercise created using the critical thinking application authoring tool 1455. The hypothesis attributes can also include an argument attribute that specifies to the application author various attributes of the argument, including each of the argument line item types that may be used to create an argument to support or falsify the hypothesis, for each of the argument line item types, the quantity, if any, that are necessary in each argument, an argument line item description attribute that is configured to receive from the application author, argument item descriptions, and all of the particular argument specific attributes of each of the line items used in that particular argument (such as allowable sequence in the argument). In some embodiments, the hypothesis attributes also include other attributes such as the attributes represented by the columns of the hypotheses specification form 1305 for the “Hypothesis” line item.

Similarly, the evidence definition module 1415, the inference and conclusion definition module 1420, the conclusion confidence level definition module 1425, and red herring item definition module 1430 generate attributes that define evidence item, inference, conclusion, conclusion confidence level and red herring item, respectively, argument items. In some embodiments, the attributes of each of the evidence item, inference, conclusion, conclusion confidence level, and red herring item can include attributes represented by the columns of the hypotheses specification form 1305. In some embodiments, the Inference and Conclusion Definition Module 1420 can be separated into two modules, one each for Inference and Conclusion.

The hint definition module 1435 generates attributes that define a hint (hereinafter simply “hint attributes”). The hint attributes can include a text phrase attribute and a cost attribute that are configured to receive from the application author information that can assist the user in solving the problem and a cost of the hint, respectively. The score definition module 1440 generates scoring attributes that are configured to receive, from the application author, data specifying scoring functions (e.g., method or formula), number of points for correct items, incorrect items etc. The feedback definition module 1445 generates attributes that are configured to receive from the application author data describing which arguments and argument items are productive and which are not, and the rationale explaining why this is so, and in the case of derived or inferred items, how such derivations and inferences are arrived at, etc.

In some embodiments, the modules 1405 to 1445 collectively define the archetype of the critical thinking exercise. The critical thinking application authoring tool creation module 1450 obtains the archetype data from the module 1405 to 1445 and creates the critical thinking application authoring tool 1455. In some embodiments, the critical thinking application authoring tool creation module 1450 can be implemented using software programming languages such as Java, C++, Perl, HTML, CSS, Javascript, JSP, PHP, etc. Further, in some embodiments, the critical thinking application authoring tool creation module 1450 can be software applications, including form based software applications such as Microsoft Excel. The critical thinking application authoring tool creation module 1450 can obtain the archetype data from the modules 1405 to 1445 and create the critical thinking application authoring tool 1455 in the corresponding software programming language or the application.

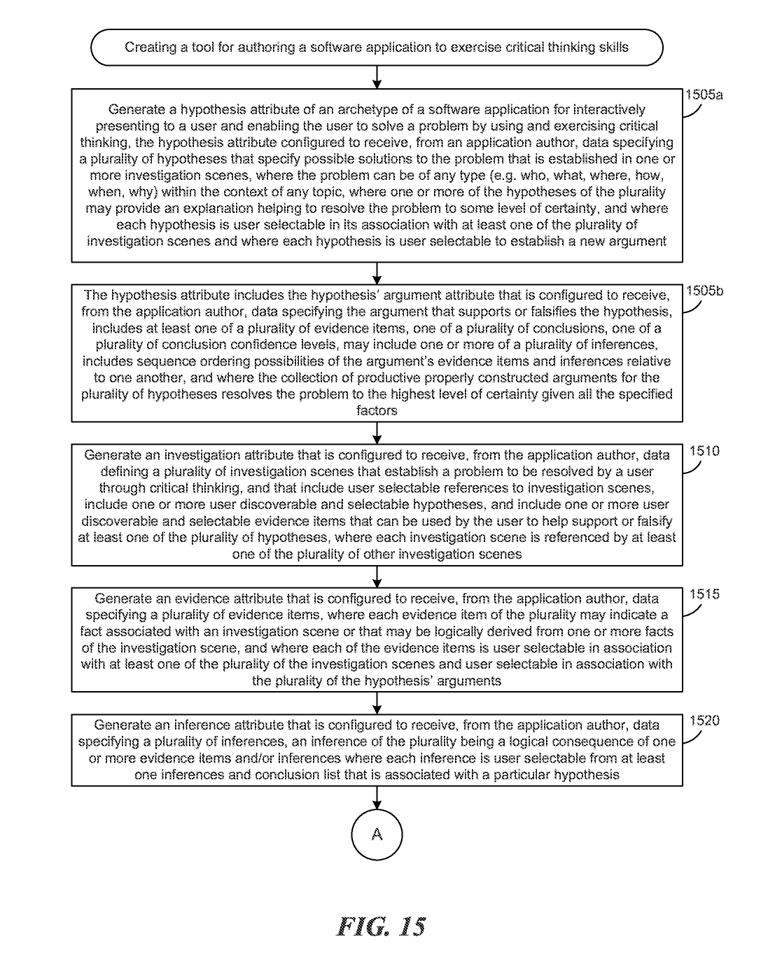

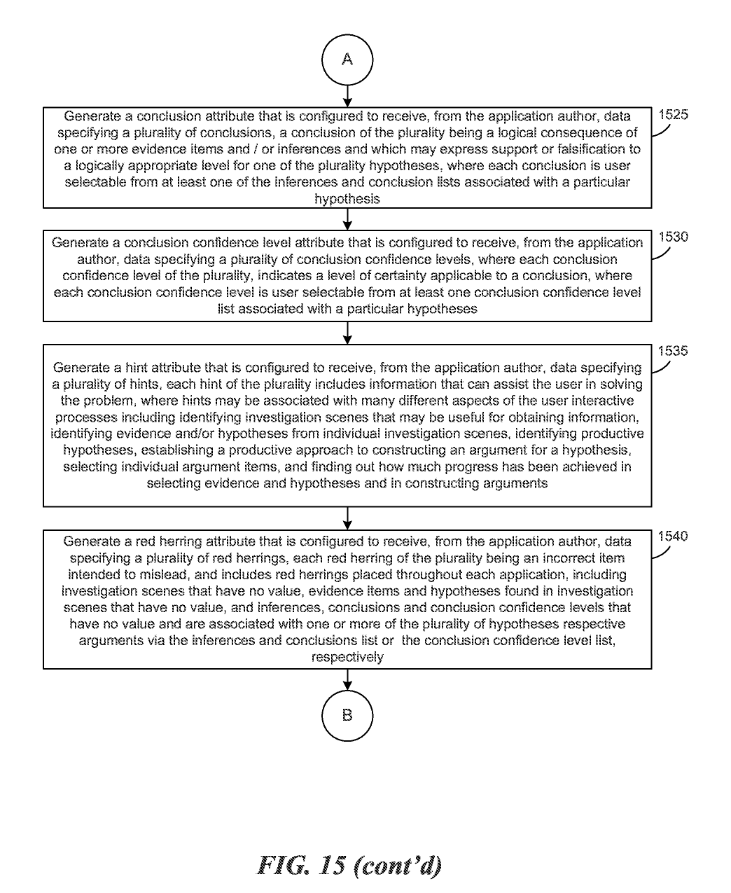

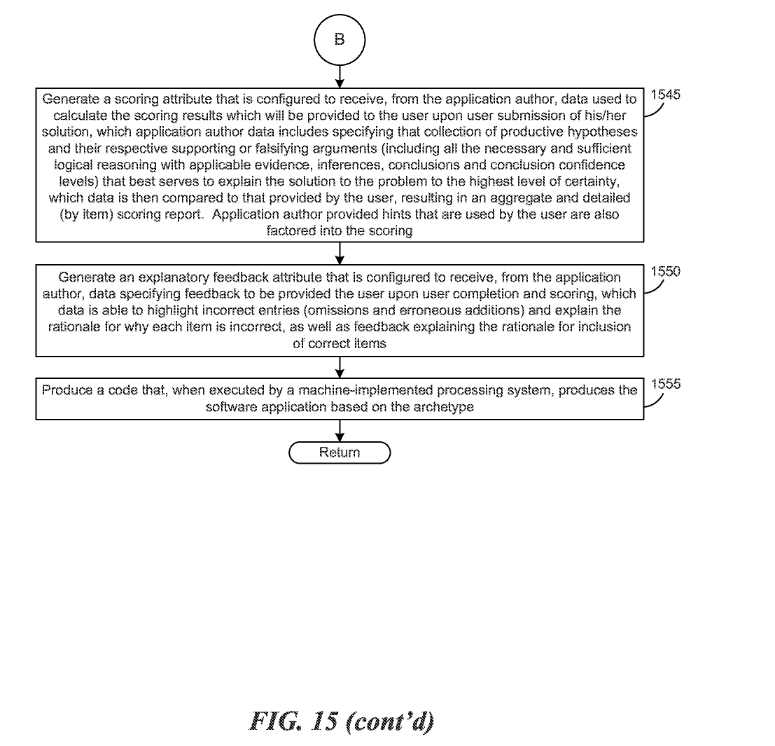

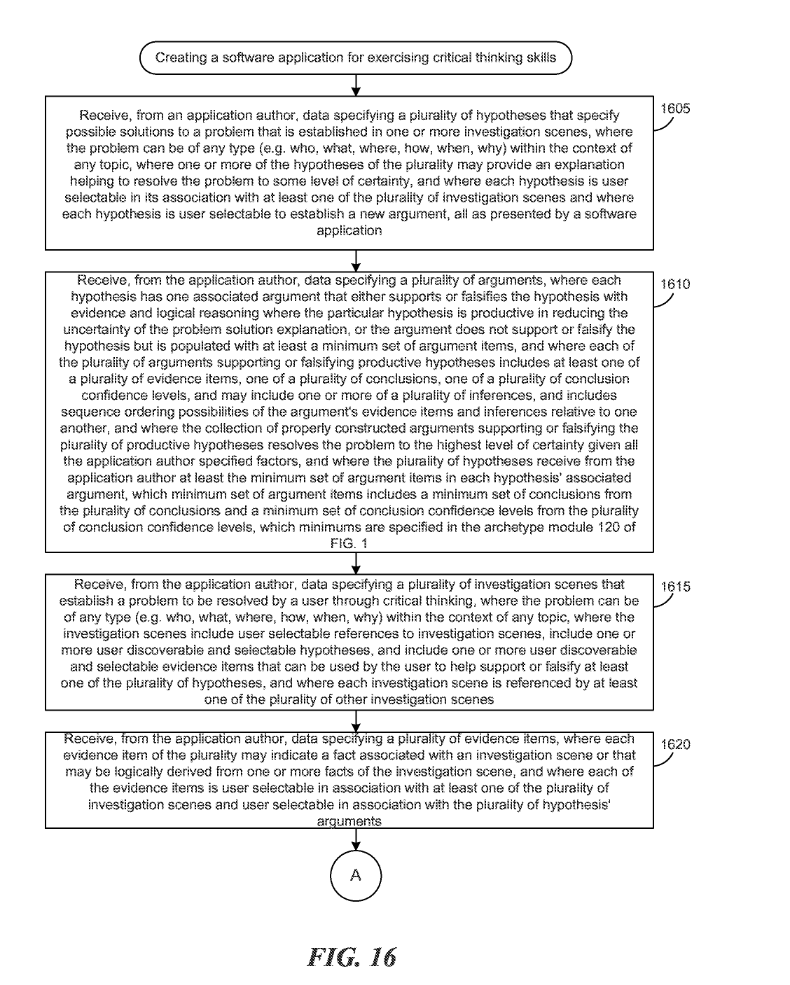

FIG. 15 is a flow diagram of a process for creating a tool for authoring a critical thinking application, according to an embodiment of the disclosed technique. In some embodiments, the process 1500 may be executed in a system such as system 1400 of FIG. 14. At step 1505 (i.e., 1505a and 1505b), the hypothesis definition module 1410 generates a hypothesis attribute of an archetype of the critical thinking application. The hypothesis attribute is configured to receive, from an application author, data specifying a plurality of hypotheses that specify possible solutions to the problem presented by the critical thinking application. The hypothesis attribute is also configured to receive, from an application author, for each of the plurality of hypotheses, data specifying the plurality of argument items addressing each of the plurality of hypotheses. In some embodiments, the hypothesis attributes also includes other hypothesis attributes such as the attributes described at least in reference to steps 1505a and 1505b of FIG. 15 and to the hypothesis definition module 1410 in FIG. 14.

At step 1510, the scene definition module 1405 generates an investigation scene attribute that is configured to receive, from the application author, data defining a plurality of investigation scenes that include multi-media objects that may convey a context and problem, references to investigation scenes, one or more hypotheses that may explain the solution to the problem, one or more evidence items that can be discovered and used by the user to help solve the problem. In some embodiments, each hypothesis and each evidence item are associated with at least one of the investigation scenes, though not necessarily the same one. In some embodiments, the investigation scene attributes also includes other investigation scene attributes such as the attributes described at least in reference to step 1510 of FIG. 15 and to the scene definition module 1405 in FIG. 14.

At step 1515, the evidence definition module 1415 generates an evidence attribute that is configured to receive, from the application author, data specifying a plurality of evidence items, where each evidence item may indicate a fact associated with and investigation scene, or may be logically derived from one or more facts in an investigation scene and may be used to help support or falsify a hypothesis. In some embodiments, each of the evidence items is associated with at least one of the investigation scenes. In some embodiments, the evidence attribute also includes other evidence attributes such as the attributes described at least in reference to step 1515 of FIG. 15 and to the evidence definition module 1415 in FIG. 14.

At step 1520, the inference and conclusion definition module 1420 generates an inference attribute that is configured to receive, from the application author, data specifying a plurality of inferences. An inference is a logical consequence of one or more evidence items and/or inferences and may be used to help support or falsify a hypothesis. In some embodiments, the inference attribute may be an optional attribute. That is, the application author may not include an inference in defining an argument associated with a hypothesis. In some embodiments, the inference attribute also includes other inference attributes such as the attributes described at least in reference to step 1520 of FIG. 15 and to the inference and conclusion definition module 1420 in FIG. 14.

At step 1525, the inference and conclusion definition module 1420 generates a conclusion attribute that is configured to receive, from the application author, data specifying a plurality of conclusions. A conclusion is a logical consequence of at least one of one or more evidence items and/or inferences, and which may express support or falsification to a logically appropriate level for one of the plurality of hypotheses. In some embodiments, the conclusion attribute also includes other conclusion attributes such as the attributes described at least in reference to step 1525 of FIG. 15 and to the inference and conclusion definition module 1420 in FIG. 14.

At step 1530, the conclusion confidence level definition module 1425 generates a conclusion confidence level attribute that is configured to receive, from the application author, data specifying a plurality of conclusion confidence levels where conclusion confidence levels indicate a level of certainty of particular conclusions for particular hypotheses. In some embodiments, the conclusion attribute also includes other conclusion attributes such as the attributes described at least in reference to step 1530 of FIG. 15 and to the confidence level definition module 1425 in FIG. 14.

At step 1535, the hint definition module 1435 generates a hint attribute that is configured to receive, from the application author, data specifying a plurality of hints that includes information that can assist the user in solving the problem at various stages of the investigation and argument construction process. In some embodiments, the hint attribute also includes other hint attributes such as the attributes described at least in reference to step 1535 of FIG. 15 and to the hint definition module 1435 in FIG. 14.

At step 1540, the red herring item definition module 1430 generates a red herring attribute that is configured to receive, from the application author, data specifying a plurality of red herring items, where a red herring item is either misleading the user or is not useful for solving the problem. In some embodiments, the red herring items can include red herring scenes, red herring hypotheses, red herring evidence items, red herring inferences, red herring conclusions, and red herring conclusion confidence levels. In some embodiments, the red herring attribute also includes other red herring attributes such as the attributes described at least in reference to step 1540 of FIG. 15 and to the red herring definition module 1430 in FIG. 14.

At step 1545, the score definition module 1440 generates a scoring attribute that is configured to receive, from the application author, data specifying scoring methods and functions about what items are assessed and in what point magnitudes, and whether there are positive points for correct items only or negative points for incorrect items as well for scoring the solution provided by the user. In some embodiments, the scoring attribute also includes other scoring attributes such as the attributes described at least in reference to step 1545 of FIG. 15 and to the score definition module 1440 in FIG. 14.

At step 1550, the feedback definition module 1445 generates a feedback attribute that is configured to receive, from the application author, data specifying the plurality of feedback items, where the plurality of feedback items highlight incorrect entries (omissions and erroneous additions) and explain the rationale for why each such item is incorrect, as well as explain the rationale for inclusion of correct items, all to be provided to the user. In some embodiments, the feedback attribute also includes other feedback attributes such as the attributes described at least in reference to step 1550 of FIG. 15 and to the feedback definition module 1445 in FIG. 14.

At step 1555, the critical thinking application tool creation module 1450 produces code representing the critical thinking application authoring tool 1455. In some embodiments, the critical thinking application authoring tool 1455 is configured to produce, when executed by a machine-implemented processing system, a code representing an application that provides, when executed by a machine-implemented processing system, the critical thinking exercise based on the archetype and the input data received from the application author for the above described attributes.

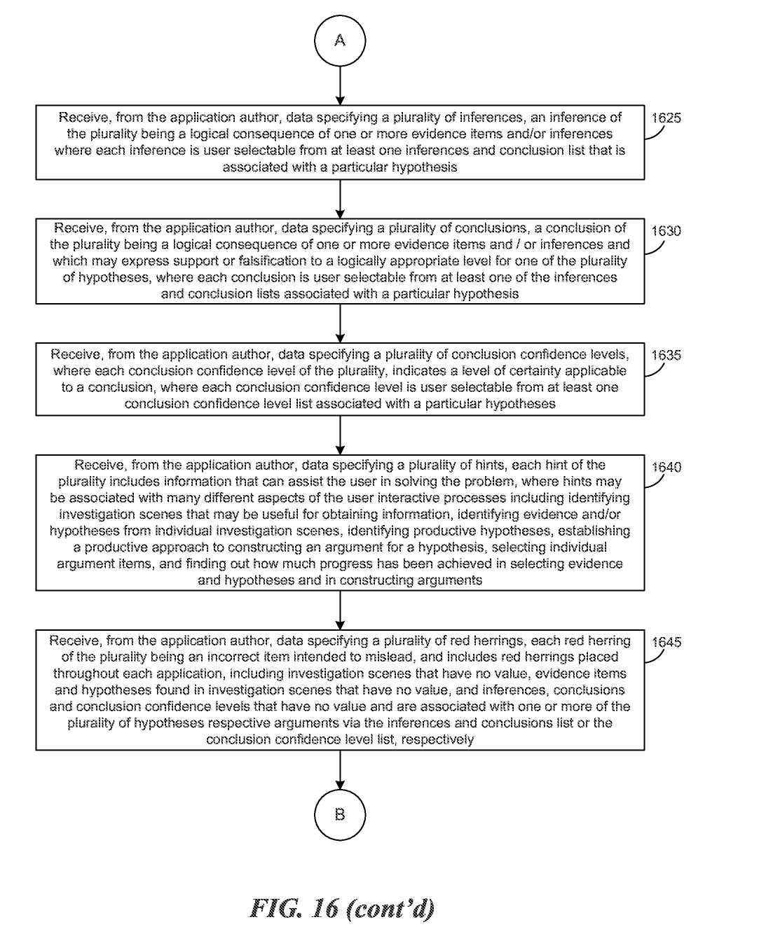

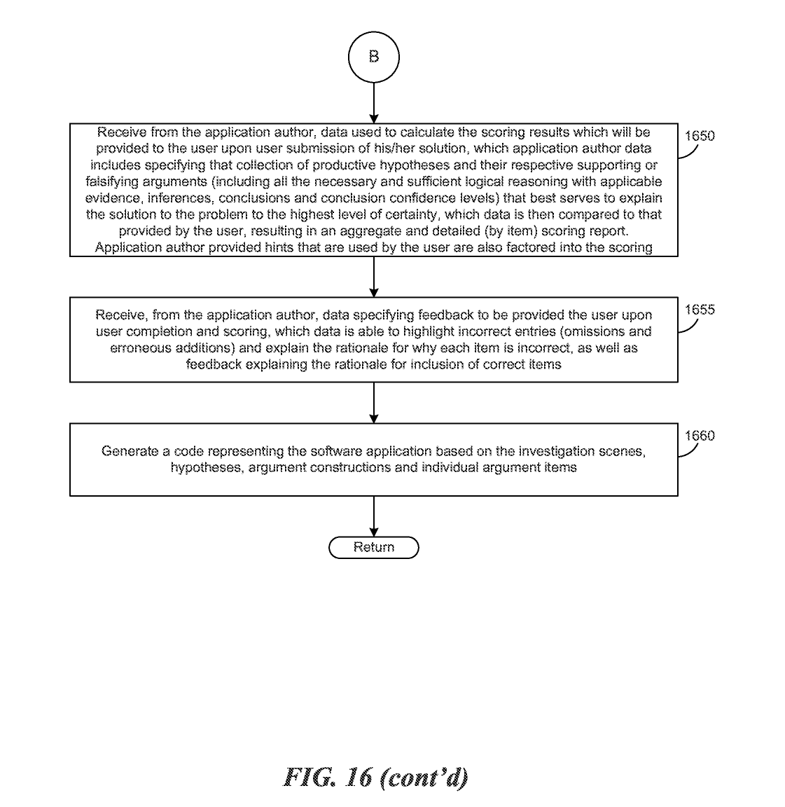

FIG. 16 is a flow diagram of a process for authoring a critical thinking application, using which a user identifies and solves a problem using and exercising critical thinking skills, according to an embodiment of the disclosed technique. In some embodiments, the process 1600 can be executed in an environment such as environment 100 of FIG. 1. A software application such as the critical thinking application 170, when executed by a machine-implemented processing system, generates a critical thinking exercise for interactively presenting to the user and enabling the user to solve a problem using critical thinking skills. In some embodiments the application author is able to specify the items presented in FIG. 16, in a non-sequential and/or iterative process, sometimes specifying items in particular arguments and sometimes specifying those same (or different) items in particular scenes. However, at the end of the specification process all items need to be entered appropriately in either their respective scenes or their particular arguments, or for some items in both at least one scene and one argument (all as has been described throughout this detail description).

At step 1605, the archetype module 120 receives, from an application author, data specifying a plurality of user selectable hypotheses that specify possible solutions to the problem presented by the critical thinking exercise and it's investigation scenes. For example, referring to the critical thinking exercise illustrated in FIGS. 3 through 13, which is the case of missing fish, a hypothesis can be a text phrase such as “Lake has been over fished, eliminating the bass population”. In some embodiments, the author can provide such information using the hypothesis specification form 1305 of the critical thinking application authoring tool 1300 of FIG. 13.

At step 1610, the archetype module 120 receives, from the application author, data specifying a plurality of user selectable argument items that form an argument for a particular hypothesis, where the application author repeats this process for each of the plurality of hypotheses. In some embodiments, the author can input such arguments using the hypothesis specification form 1305 of the critical thinking application authoring tool 1300 of FIG. 13. Each of the hypotheses and evidence items entered in an argument must also be entered in association with at least one investigation scene, (i.e., in a scene's Potential Hypotheses list or a scene's Potential Evidence list). The inferences, conclusions and conclusion confidence levels are entered in particular arguments and will appear to the user in either the particular hypothesis' argument's inferences and conclusion list or the particular hypothesis' argument's conclusion confidence level list respectively. In certain embodiments, the inferences and conclusion list could be two separate lists as they appear to the user, but this does not affect the application author specification, nor would it affect when the items appear to the user (i.e., each inference, conclusion, and conclusion confidence level appears to the user upon the user attempting to support or falsify the hypothesis to which each of these items are associated by the application author).

At step 1615, the archetype module 120 receives, from the application author, data specifying a plurality of investigation scenes that can include multi-media objects, expression of the problem, user selectable references to investigation scenes and user selectable potential hypotheses and evidence items that the user may use to help solve the problem. For example, referring to the case of missing fish, an investigation scene can include a video of an interview with a person such as a park ranger of a park having the lake. In this particular video, the user learns that there is a crisis in Willow Lake, it is the beginning of the fishing season, which is a commercially important sport for the community, but there are no fish! The park ranger is lamenting that no one can find any fish and is asking the user to help determine what has happened to the previously believed, robust fish population. In some embodiments, the author can input such a video using the scene specification form 1350 of the critical thinking application authoring tool 1300 of FIG. 13.

At step 1620, the archetype module 120 receives, from the application author, a plurality of user selectable evidence items which are to appear on particular Potential Evidences lists associated with particular scenes and also can be used in arguments to help support or falsify a hypothesis. Evidence can appear directly in the scene or be derived from one or more items in the scene. For example, referring to the case of the missing fish, the park ranger mentions on FIG. 7 and as shown on Potential Evidence List 705, that the lake is 5,000 acres (one piece of evidence) and was stocked with 150,000 bass (a second piece of evidence). From these two evidence items of this scene, the user may derive that the stocking density of the lake was 30 fish per acre (i.e., 150,000 fish divided by 5,000 acres), resulting in third (derived-compound) evidence item. There are several red herring evidence items on Potential Evidence list 705, such as the entry that the lake is 5,000 hectares, or that the lake had a stocking density of 20 or 40 fish per acre. Each evidence item is associated with at least one investigation scene. Some of the plurality of evidence items are also applied in argument specifications as referenced in Step 1610 and as can be seen on FIG. 10 for some of the line items 1015.

At step 1625, the archetype module 120 receives, from the application author, a plurality of user selectable inferences that are logical consequences of prior evidence items and or inferences. For example, referring to the case of missing fish, an inference can be a text phrase such as “Since our 15% harvest is less than the 16% of the graphed model scenario, and our original stock of 30 fish/acre is greater than the 20 fish/acre, the model will predict a population in 2011 greater than 50% of the original stocked population” as can be seen on FIG. 8 inferences and conclusions list 805, and as applied in FIG. 10, one of the lines in 1015. Inferences are associated with particular hypotheses and the hypotheses particular arguments and can be used to help support or falsify the applicable hypothesis.

At step 1630, the archetype module 120 receives, from the application author, a plurality of user selectable conclusions, wherein each is a logical consequence of prior argument items and may support or falsify a hypothesis to some appropriate level of certainty. For example, referring to the case of missing fish, one conclusion can be a text phrase such as “Given the worst case scenario for the factors affecting our population, the model predicts robust fish population, therefore lake was NOT overfished.” Conclusions are associated with particular hypotheses and the hypotheses particular arguments.

At step 1635, the archetype module 120 receives, from the application author, the plurality of user selectable conclusion confidence levels, where a conclusion confidence level indicates a level of certainty of a conclusion for a particular hypothesis. Conclusion confidence levels are associated by application authors with the conclusions to particular hypotheses. One example of a conclusion confidence level from the case of missing fish is the use of the text phrase conclusion confidence level: “Beyond any reasonable doubt.” Proving to 100% certainty is not always possible. An important aspect of critical thinking is to identify the correct level of certainty in the solution asserted. One approach is to discover as many explanations that can solve the problem as possible and to falsify as many of those as possible, leaving the remaining possible answers to be supported to some greater or lesser extent, each assigned it's own level of certainty. When multiple possible answers exist, or the possibility of an as yet discovered explanation still exists, the level of certainty about an answer cannot be 100%. Often it is much easier to falsify a possibility to 100% certainty. Should the application author find this lack of certainty unappealing, he/she can construct a closed system critical thinking exercise, where he/she designs some finite set possible explanations, with all but one being falsifiable, leaving the remaining non-falsifiable explanation as the only possible one, and thus 100% certain. Both modes are possible with this authoring tool; it is within the control of the application author to make such critical thinking exercise design decisions.

At step 1640, the archetype module 120 receives, form the application author, data specifying a plurality of hints that include information that can assist the user in solving the problem. For example, referring to the case of missing fish, a hint can be a text phrase providing information such as “Select hypothesis ‘Virus has killed the fish’ from investigation scene ‘Park Ranger.’”

At step 1645, the archetype module 120 receives, from the application author, data specifying a plurality of red herrings that can either mislead the user from solving the problem, or is not useful in solving the problem. For example, referring to the case of missing fish, a red herring can be an evidence item that the stocking density was 20 fish/acre as presented on the Potential Evidence list 705 of FIG. 7. If the user selected and used this (incorrect evidence), they would find that the population model graph (from an investigation scene not shown) predicts a “fished out” lake; which is not the case. Instead, at 30 fish/acre stocking density, which is the case, the model graph predicts a healthy lake. Thus, implanting of red herring evidence is just one means for altering the challenge and difficulty of the exercise, which can range from very simple (rated for a 7 year old) to very difficult (rated for post-doctoral academics). Other means of altering the level of challenge beyond the numerous types of red herrings includes in various embodiments: number of scenes, proximity of scenes containing importantly related data, navigational complexity (i.e., breadth and depth of the scene referral connections), number of items on the various lists in scenes and at argument construction, ambiguity of wordings of items on lists, number of arguments to be solved, length and logical complexity of arguments, complexity of the underlying topical material providing the exercise context, to name a few.

At step 1650, the archetype module 120 receives, from the application author, data used to calculate the scoring results which will be provided to the user upon user submission of his/her solution, which application author data includes: scoring methods and functions about what items are assessed and in what point magnitudes, and whether there are positive points for correct items only or negative points for incorrect items as well. Scoring data also includes specifying the application author prescribed answer against which user solutions are compared, namely: that collection of productive hypotheses and their respective supporting or falsifying arguments (including all the necessary and sufficient logical reasoning with applicable evidence, inferences, conclusions and conclusion confidence levels) that best serves to explain the solution to the problem to the highest level of certainty, which data is then compared to that provided by the user, resulting in an aggregate and detailed (by item) scoring report. Application author hints that are used by the user are also factored into the scoring. Scoring analysis 1105 from FIG. 11 is an example of the scoring results that can be derived from the application author's specifications when compared, argument item by argument item to that of the user.

At step 1655, the archetype module 120 receives, from the application author, data specifying the plurality of feedback to be provided to the user upon submission of the solution by the user. In some embodiments, the feedback can highlight incorrect entries (omissions and erroneous additions) and explain the rationale for why each item is incorrect, as well as feedback explaining the rationale for inclusion of correct entries. For example, referring to the case of missing fish, the feedback 1210 of FIG. 12 provided by the author can include an explanation such as “insert: <Maximum annual harvest=15%>; The size of the annual harvest is a major factor affecting the growth in population. The maximum annual harvest is largest harvest for any year in the history of the lake. Modeling the population using the MAXIMUM harvest for EVERY year since stocking the lake will yield the smallest possible (i.e., the worst case) remaining population. If the model still shows strong fish population after using the maximum harvest for each year, then overfishing is not likely at all” which suggests that the user should have included the argument item “<Maximum annual harvest=15%>” in the solution.

At step 1660, the critical thinking application authoring tool 115 generates code representing the critical thinking application based at least on the investigation scenes, hypotheses, argument constructions, and the individual argument items provided by the application author.

In some embodiments, the critical thinking application can be stored in and made available to the user from a repository or a library of critical thinking exercises. A user may download one or more of the critical thinking applications from the library to their local devices. In some other embodiments, the critical thinking applications can be accessed directly from the library, that is, the critical thinking application can be implemented in an online configuration where the user can solve the problem presented by the critical thinking exercise without having to download (or downloading only a portion of) the critical thinking application to the user's local device. In some other embodiments, the critical thinking applications can be stored on other non-transitory computer readable media.

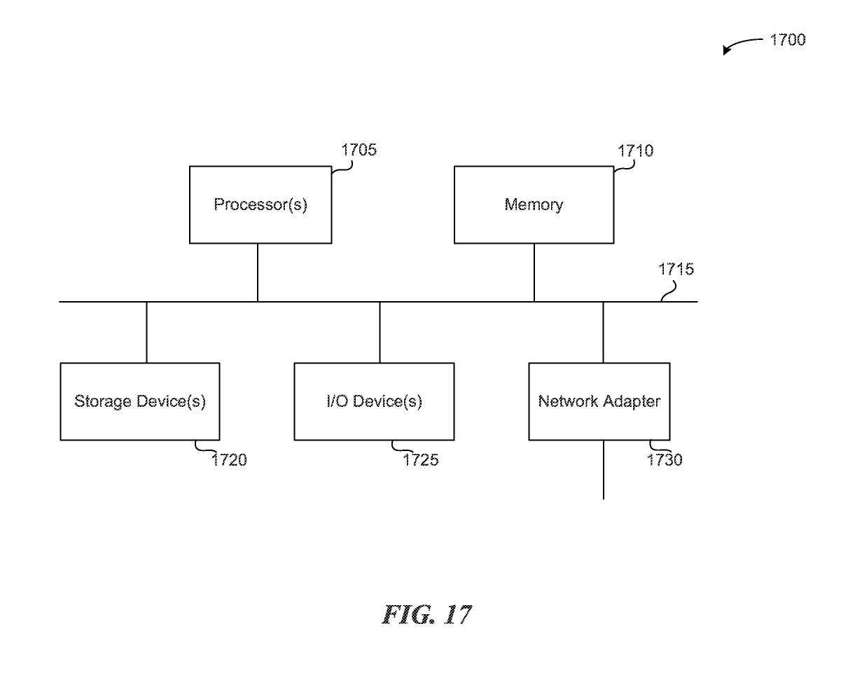

FIG. 17 is a block diagram of processing system that can perform the operations, and store various information generated and/or used by such operations, of the technique disclosed about. The processing system can represent a personal computer (PC), tablet computer, server class computer, workstation, smart phone, etc. The processing system 1700 is a hardware device on which any of the entities, components or services depicted in the examples of FIGS. 1-16 (and any other components described in this specification), such as logical exercise authoring tool 115, 1450, logical exercise 170, archetype module 120, hypothesis specification form 1305, scene specification form 1350, etc. can be implemented. The processing system 1700 includes one or more processors 1705 and memory 1710 coupled to an interconnect 1715. The interconnect 1715 is shown in FIG. 17 as an abstraction that represents any one or more separate physical buses, point to point connections, or both connected by appropriate bridges, adapters, or controllers. The interconnect 1715, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 1705 is/are the central processing unit (CPU) of the processing system 1700 and, thus, control the overall operation of the processing system 1700. In certain embodiments, the processor(s) 1705 accomplish this by executing software or firmware stored in memory 1710. The processor(s) 1705 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 1710 is or includes the main memory of the processing system 1700. The memory 1710 represents any form of random access memory (RAM), read-only memory (ROM), flash memory, or the like, or a combination of such devices. In use, the memory 1710 may contain a code. In one embodiment, the code includes a general programming module configured to recognize the general-purpose program received via the computer bus interface, and prepare the general-purpose program for execution at the processor. In another embodiment, the general programming module may be implemented using hardware circuitry such as ASICs, PLDs, or field-programmable gate arrays (FPGAs).

Also connected to the processor(s) 1705 through the interconnect 1715 are a network adapter 1730, a storage device(s) 1720 and I/O device(s) 1725. The network adapter 1730 provides the processing system 1700 with the ability to communicate with remote devices, over a network and may be, for example, an Ethernet adapter or Fibre Channel adapter. The network adapter 1730 may also provide the processing system 1700 with the ability to communicate with other computers within the cluster. In some embodiments, the processing system 1700 may use more than one network adapter to deal with the communications within and outside of the cluster separately.

The I/O device(s) 1725 can include, for example, a keyboard, a mouse or other pointing device, disk drives, printers, a scanner, and other input and/or output devices, including a display device. The display device can include, for example, a cathode ray tube (CRT), liquid crystal display (LCD), or some other applicable known or convenient display device.

The code stored in memory 1710 can be implemented as software and/or firmware to program the processor(s) 1705 to carry out actions described above. In certain embodiments, such software or firmware may be initially provided to the processing system 1700 by downloading it from a remote system through the processing system 1700 (e.g., via network adapter 1730).

The techniques introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine.

A machine can also be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

A machine-accessible storage medium or a storage device(s) 1720 includes, for example, recordable/non-recordable media (e.g., ROM; RAM; magnetic disk storage media; optical storage media; flash memory devices; etc.), etc., or any combination thereof. The storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state.

The term “logic”, as used herein, can include, for example, programmable circuitry programmed with specific software and/or firmware, special-purpose hardwired circuitry, or a combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

I/We claim:

1. A method of authoring a software application, the method comprising:
outputting, to an application author at a machine-implemented processing system, data representing an archetype of the software application for presenting to a user a problem and for enabling the user to solve the problem through identification of an unresolved question in the problem and resolution of the question by use of logical reasoning, the archetype including
an investigation scene attribute to receive, from the application author, data defining a plurality of investigation scenes that include evidence for discovery and use by the user to resolve the question, each of the investigation scenes associated with at least one other investigation scene,
a hypothesis attribute to receive, from the application author, data specifying a plurality of hypotheses that specify possible explanations resolving the question, and
an argument attribute to receive, from the application author, data specifying a plurality of arguments that support or falsify the plurality of hypotheses;
inputting, at the machine-implemented processing system and from the application author, the data specifying the plurality of investigation scenes, the data specifying the plurality of hypotheses and the data specifying the plurality of arguments, as input parameters; and
generating, by the machine-implemented processing system, code embodying the software application based on the archetype and the input parameters.

2. The method of claim 1, wherein each of the investigation scenes comprises multi-media content including at least one of: (i) a still image, (ii) a video clip, (iii) an audio clip, (iv) a text, (v) a document, (vi) an animation, or (vii) a graphic.

3. The method of claim 1, wherein receiving the arguments includes receiving, from the application author, for each argument of the plurality of arguments, a plurality of user selectable argument items that is associated with that argument, the argument items including
a plurality of user selectable evidence items, the evidence items indicating facts associated with or derivable from the facts associated with the investigation scenes, each of the evidence items associated with at least one of the investigation scenes,
a plurality of user selectable inferences, an inference of the inferences being an intermediate conclusion of a particular hypothesis based on one or more evidence items and one or more inferences of the plurality of user selectable inferences,
a plurality of user selectable conclusions, a conclusion of the plurality of conclusions being a deduction of the particular hypothesis based on at least one of the particular evidence item or a particular inference, the conclusion supporting or falsifying the particular hypothesis addressed by the conclusion, and
a plurality of user selectable confidence levels of a conclusion, a confidence level of the confidence levels indicating a level of certainty of a particular conclusion for the particular hypothesis.

4. The method of claim 3, wherein each evidence item of the evidence items has a first sequence indicator indicating possible correct sequence positions of the evidence item relative to remaining of the evidence items and the inference items in the argument, and wherein each inference of the inferences has a second sequence indicator indicating possible correct sequence positions of the inference relative to remaining of the evidence items and the inference items in the argument.

5. The method of claim 3, wherein receiving the data specifying input parameters further includes receiving, from the application author,
data specifying a plurality of hints, the hints including information that can assist the user in solving the problem, and
data specifying a plurality of a predefined number of user selectable red herring evidence items, red herring inferences, red herring conclusions and red herring confidence levels that are either misleading or not useful in solving the problem.

6. The method of claim 5, wherein receiving data specifying the hints includes receiving at least one of (i) a number of pertinent hypotheses associated with a particular investigation scene, (ii) a description assisting the user with identifying one or more pertinent hypotheses associated with the particular investigation scene, (iii) a number of pertinent evidence items to be identified in the particular investigation scene, (iv) a description of an argument that can be made to support or falsify the particular hypothesis, or (v) a source of an argument item of the argument.

7. The method of claim 3, wherein receiving data specifying the input parameters further includes receiving, from the application author, data to be provided as feedback to the user, the feedback including a description about at least one of (a) why a particular argument item included in the argument by the user is incorrect or correct or (b) if the particular argument item is derived from any of remaining of the argument items, how the particular argument item is derived.

8. The method of claim 3, wherein receiving each of the plurality of hypotheses and each of the argument items includes receiving each of the plurality of hypotheses and each of the arguments as a text phrase.

9. A method of interactively presenting to a user a problem and for enabling the user to solve the problem through identification of an unresolved question in the problem and resolution of the question by use of logical reasoning, the method comprising:
outputting to the user, at a machine-implemented processing system, a plurality of investigation scenes that include evidence to be discovered and used by the user to solve the problem in logical reasoning;
outputting to the user, in association with the plurality of investigation scenes, (a) a plurality of predefined user selectable hypotheses that specify possible solutions to the problem and (b) a plurality of predefined user selectable argument items that can be used to create a plurality of arguments that support or falsify the plurality of hypotheses and resolve the question in the problem;
receiving by the user (a) a selection of at least one of the plurality of predefined user selectable hypotheses to generate a user selected hypothesis and (b) a selection of at least one of the plurality of predefined user selectable argument items to generate a user constructed argument that supports or falsifies the user selected hypothesis; and
generating and outputting a score of the user, based at least partly on the user selected hypothesis and the user constructed argument.

10. The method of claim 9, wherein each of the investigation scenes is a multi-media content including at least one of: (i) a still image, (ii) a video clip, (iii) an audio clip, (iv) a text, (v) a document, (vi) an animation, or (vii) a graphic.

11. The method of claim 9, wherein the predefined user selectable argument items include:
a plurality of user selectable evidence items, the evidence items indicating facts associated with the investigation scenes, each of the evidence items associated with at least one of the investigation scenes,
a plurality of user selectable conclusions, a conclusion of the conclusions being a deduction of the particular hypothesis based on at least one of a particular evidence item or a particular inference, the conclusion supporting or falsifying the particular hypothesis addressed by the conclusion, and
a plurality of user selectable confidence levels of a conclusion, a confidence level of the confidence levels indicating a level of certainty of a particular conclusion for the particular hypothesis.

12. The method of claim 11, wherein the predefined user selectable argument items further include a plurality of user selectable inferences, an inference of the user selectable inferences being an intermediate conclusion of a particular hypothesis based on one or more evidence items of the plurality of evidence items and one or more inferences of the plurality of inferences.

13. The method of claim 11, wherein at least one of (a) the investigation scenes, (b) the hypotheses, (c) the evidence items, (d) the inferences, (e) the conclusions or (f) the confidence levels of a conclusion include information that can either mislead or is useless for the user in solving the problem.

14. The method of claim 11, wherein receiving a selection of the plurality of predefined user selectable argument items includes receiving
a user selected evidence item of the evidence items that indicates a fact associated with or derived from a fact associated with a particular investigation scene,
a user selected inference of the inferences that is inferred based on the user selected evidence item,
a user selected conclusion of the conclusions that supports or falsifies the user's selection of the at least one of the plurality of predefined user selectable hypotheses based on at least one of the user selected evidence item or the user selected inference, and
a user selected confidence level that indicates the confidence level of the user for the user selected conclusion.

15. The method of claim 14, wherein generating and outputting a score of the user includes:
comparing at least one of the user selected evidence item, the user selected inference, the user selected conclusion, the user selected confidence level with the corresponding application author defined evidence, application author defined inference, application author defined conclusion, or application author defined confidence level for the user's selection of the at least one of the plurality of predefined user selectable hypotheses, the application author being an author of the problem.

16. The method of claim 9 further comprising:
outputting, upon receiving a request from the user, a hint to the user, the hint including information that can assist the user in deciding to select a particular argument item from the plurality of predefined user selectable argument items.

17. The method of claim 16 further comprising:
adjusting the score as a function of number of hints provided to the user.

18. The method of claim 9, wherein outputting the plurality of investigation scenes to the user further includes:
outputting at least one of the plurality of investigation scenes in a restricted reveal format, the restricted reveal format including
preventing access to a first investigation scene of the investigation scenes until a second investigation scene of the investigation scenes is accessed according to a predefined criterion for revealing the first investigation scene.

19. An apparatus for authoring a software application, the apparatus comprising:
a processor;
an archetype module invocable by the processor to output an archetype of the software application, the software application being an application designed to interactively present to a user a problem and to enable the user to solve the problem through identification of an unresolved question in the problem and resolution of the question by use of logical reasoning, the archetype including
an investigation scene attribute to receive, from the application author, data defining a plurality of investigation scenes that include evidence for discovery and use by the user to solve the problem, each of the investigation scenes associated with at least one other investigation scene,
a hypothesis attribute to receive, from the application author, data specifying a plurality of hypotheses that specify possible explanations resolving the question, and
an argument attribute to receive, from the application author, data specifying a plurality of arguments that support or falsify the plurality of hypotheses; and
a software application creation module invocable by the processor to produce code embodying the software application based on the archetype.

20. The apparatus of claim 19, wherein the argument attribute of the archetype further includes
an evidence attribute to receive, from the application author, data specifying a plurality of evidence items, the evidence items indicative of facts associated or derivable from the facts associated with the investigation scenes, each of the evidence items associated with at least one of the investigation scenes,
an inference attribute to receive, from the application author, data specifying a plurality of inferences, an inference of the inferences being an intermediate conclusion of a particular hypothesis based on at least one of a particular evidence item or another inference of the plurality of inferences that addresses the particular hypothesis,
a conclusion attribute to receive, from the application author, data specifying a plurality of conclusions, a conclusion of the conclusions being a deduction of the particular hypothesis based on at least one of the particular evidence item or the inference addressing the particular hypothesis, and
a confidence level attribute to receive, from the application author, data specifying a confidence level of a particular conclusion, the confidence level indicating a level of certainty of the particular conclusion for the particular hypothesis.

21. The apparatus of claim 20, wherein a combination of (a) the particular evidence item, (b) the particular inference, (c) the particular conclusion and (d) the confidence level for the particular hypothesis forms an argument for the particular hypothesis, the particular hypothesis and the argument providing a solution to the problem.

22. The apparatus of claim 21 further comprising:
a score determination module configured to determine a score for the solution to the problem as a function of a user generated argument and an application author defined argument for the particular hypothesis.

23. The apparatus of claim 22, wherein the archetype further includes a hint attribute to receive, from the application author, data specifying a hint that can assist the user in solving the problem.

24. The apparatus of claim 23, wherein the hint is associated with a cost that can decrease the score of the user.

25. The apparatus of claim 24, wherein the score determination module is further configured to adjust the score as a function of the cost of the hint provided to the user.

26. The apparatus of claim 23, wherein the archetype further includes a red herring attribute to receive, from the application author, data specifying a misleading argument item, the misleading argument item including at least one of a misleading hypothesis, a misleading evidence item, a misleading inference, a misleading conclusion, or a misleading confidence level designed to either mislead or be not useful to the user in solving the problem.

27. The apparatus of claim 26, wherein the archetype further includes data specifying at least one of a minimum number of hints or a minimum number of misleading argument items to be included in the software application by the application author.

28. A method of creating an authoring tool for authoring a software application, the method comprising:
generating, at a machine-implemented processing system, an archetype of the software application, the software application for interactively presenting to a user a problem and for enabling the user to solve the problem through identification of an unresolved question in the problem and resolution of the question by use of logical reasoning, the archetype including
an investigation scene attribute to receive, from the application author, data defining a plurality of investigation scenes that include evidence for discovery and use by the user to solve the problem, each of the investigation scenes associated with at least one other investigation scene,
a hypothesis attribute to receive, from the application author, data specifying a plurality of hypotheses that specify possible explanations resolving the question, and
an argument attribute to receive, from the application author, data specifying a plurality of arguments that support or falsify the plurality of hypotheses; and
producing, by the machine-implemented processing system, a first code that, when executed by another machine-implemented processing system, produces the software application based on the archetype.

29. The method of claim 28, wherein each of the investigation scenes is a multi-media content including at least one of: (i) a still image, (ii) a video clip, (iii) an audio clip, (iv) a text, (v) a document, (vi) an animation, or (vii) a graphic.

30. The method of claim 28, where in each of the plurality of hypotheses is associated with at least one of the plurality of investigation scenes.

31. The method of claim 28 wherein generating the argument attribute of the archetype includes
generating an evidence attribute to receive, from the application author, data specifying a plurality of evidence items, the evidence items indicative of facts associated or derivable from the facts associated with the investigation scenes, each of the evidence items associated with at least one of the investigation scenes,
generating an inference attribute to receive, from the application author, data specifying a plurality of inferences, an inference of the inferences being an intermediate conclusion of a particular hypothesis based on at least one of a particular evidence item or another inference of the plurality of inferences that addresses the particular hypothesis,
generating a conclusion attribute to receive, from the application author, data specifying a plurality of conclusions, a conclusion of the conclusions being a deduction of the particular hypothesis based on at least one of the particular evidence item or the inference addressing the particular hypothesis, and
generating a confidence level attribute to receive, from the application author, data specifying a confidence level of a particular conclusion, the confidence level indicating a level of certainty of the particular conclusion for the particular hypothesis

32. The method of claim 31, wherein the hypothesis attribute, the evidence attribute, the inference attribute, the conclusion attribute, and the confidence level attribute are configured to receive the data specifying hypotheses, evidence items, inferences, conclusions, and the confidence level, respectively, as text.

33. The method of claim 28, wherein producing the first code includes producing code for a scoring module to generate, when executed in association with the software application, a score report for the user, the score report including at least one of (i) a score of the user for a solution provided by the user, the solution including a user selection of a particular hypothesis from the hypotheses and a user selection of an argument from the arguments supporting or falsifying the particular hypothesis, (ii) a score by type of argument attribute, (iii) a history of scores, the history including scores of a plurality of problems solved by the user, or (iv) a comparison of a score of the user with a group of users.

34. The method of claim 28, wherein generating the archetype further includes generating a hint attribute to receive, from the application author, data specifying a hint that provides at least one of (i) a number of pertinent hypotheses in the software application, (ii) a number of pertinent hypotheses remaining to be identified by the user for solving the problem, (iii) a number of pertinent hypotheses and evidence items that should have been identified, by the user for solving the problem, (iv) a number of hypotheses missing and remaining to be correctly identified by the user, (v) a number of evidences in the software application, or (vi) a number of evidences that are missing from a user generated argument.

35. The method of claim 28, wherein generating the archetype further includes generating a red herring attribute to receive, from the application author, data specifying a plurality of user selectable red herring evidence items, red herring inferences, red herring conclusions and red herring confidence levels that are either misleading or not useful in solving the problem.
